(19) United States
(12) Patent Application Publication
(10) Pub. No.: US 2022/0319515 A1
(43) Pub. Date: Oct. 6, 2022

(54) INFORMATION PROCESSING DEVICE, INFORMATION PROCESSING SYSTEM, INFORMATION PROCESSING METHOD, AND PROGRAM

(71) Applicant: SONY GROUP CORPORATION, TOKYO (JP)

(72) Inventor: KATSUTOSHI KANAMORI, TOKYO (JP)

(21) Appl. No.: 17/753,853

(22) PCT Filed: Aug. 6, 2020
(86) PCT No.: PCT/JP2020/030193

§ 371 Date: Mar. 16, 2022

(30) Foreign Application Priority Data
Sep. 25, 2019 (JP) 2019-174047

(51) Int. Cl. G10L 15/22; G10L 13/02; G10L 15/30; G05D 1/00

(52) U.S. Cl. CPC G10L 15/22; G10L 13/02; G10L 15/30; G05D 1/0016; G10L 2015/228; G10L 2015/223

(57) ABSTRACT

A configuration in which an optimum system utterance is selected and output from a plurality of system utterances generated by a plurality of dialogue execution modules that generate system utterances in accordance with different algorithms is realized. A data processing unit generating and outputting system utterances selects one system utterance from among a plurality of system utterances individually generated by the plurality of dialogue execution modules and outputs the selected system utterance. Each of the plurality of dialogue execution modules generates algorithm-specific system utterances in accordance with different algorithms. The data processing unit selects one system utterance to be output in accordance with the degree of confidence which is set to correspond to a system utterance generated by each of the plurality of dialogue execution modules and a predefined dialogue execution module-compatible priority.

### TECHNICAL FIELD

The present disclosure relates to an information processing device, an information processing system, an information processing method, and a program. More specifically, the present disclosure relates to an information processing device, an information processing system, an information processing method, and a program for executing processing based on a speech recognition result of a user utterance.

### BACKGROUND ART

In recent years, the use of a speech recognition system that performs speech recognition of a user utterance and makes a response based on a recognition result has been increasing.

The speech recognition system analyzes a user utterance which is input through a microphone and makes a response based on an analysis result.

For example, in a case where a user utters “Tell me what the weather will be like tomorrow.”, weather information is acquired from a weather information providing server, a system response based on the acquired information is generated, and the generated response is output through a speaker. Specifically, for example, following system speech is output.

System speech=“It will be clear tomorrow. But there may be a thunderstorm in the evening.”

Such a system utterance output device has an analysis processing function for a user utterance and a data processing function of generating a response based on an analysis result. A module that executes the data processing function is referred to as a “dialogue execution module”, a “dialogue engine”, or the like.

There are various types of dialogue execution modules (dialogue engines).

For example, PTL 1 (JP 2003-280683 A) discloses a configuration for realizing dialogues corresponding to specialized fields by using dictionaries according to fields.

By using the technology disclosed in PTL 1, specialized dialogues in fields recorded in a dictionary can be performed. However, when information for performing a daily conversation is not recorded in a dictionary, there is a possibility that a daily conversation will not be performed successfully.

In this manner, depending on the type and function of a dialogue execution module used by a device, there are cases where a smooth dialogue can be performed and where a dialogue is unnatural or a dialogue is completely impossible.

### CITATION LIST

### Patent Literature

[PTL 1]
JP 2003-280683 A

### SUMMARY

### Technical Problem

The present disclosure is contrived in view of, for example, the above-described problems, and an object thereof is to provide an information processing device, an information processing system, an information processing method, and a program which make it possible to perform optimum dialogues corresponding to various situations by selectively using a plurality of different dialogue execution modules (dialogue engines).

### Solution to Problem

A first aspect of the present disclosure is an information processing device including a data processing unit configured to generate and output a system utterance, in which the data processing unit selects one system utterance from among a plurality of system utterances individually generated by a plurality of dialogue execution modules and outputs the selected system utterance.

Further, a second aspect of the present disclosure is an information processing system including a robot control device that controls a dialogue robot, and a server that is able to communicate with the robot control device, in which the robot control device outputs situation information input through an input unit to the server, the server includes a plurality of dialogue execution modules that generate system utterances in accordance with different system utterance generation algorithms, each of the plurality of dialogue execution modules generates an individual system utterance based on the situation information and transmits the generated system utterance to the robot control device, and the robot control device selects one system utterance from among the plurality of system utterances received from the server and outputs the selected system utterance.

Further, a third aspect of the present disclosure is an information processing method executed in an information processing device, in which the information processing device includes a data processing unit that generates and outputs a system utterance, and the data processing unit selects one system utterance from among a plurality of system utterances individually generated by a plurality of dialogue execution modules and outputs the selected system utterance.

Further, a fourth aspect of the present disclosure is an information processing method executed in an information processing system including a robot control device that controls a dialogue robot, and a server that is able to communicate with the robot control device, in which the robot control device outputs situation information input through an input unit to the server, the server includes a plurality of dialogue execution modules that generate system utterances in accordance with different system utterance generation algorithms, each of the plurality of dialogue execution modules generates an individual system utterance based on the situation information and transmits the generated system utterance to the robot control device, and the robot control device selects one system utterance from among the plurality of system utterances received from the server and outputs the selected system utterance.

Further, a fifth aspect of the present disclosure is a program for executing information processing in an information processing device, in which the information processing device includes a data processing unit that generates and outputs a system utterance, and the program causes the data processing unit to select one system utterance from among a plurality of system utterances individually generated by a plurality of dialogue execution modules and output the selected system utterance.

Note that the program of the present disclosure is, for example, a program that can be provided by a storage medium provided in a computer-readable form or provided by a communication medium, the program being provided to an information processing device or a computer system that can execute various program codes. By providing such a program in a computer-readable form, processing according to the program can be realized on an information processing device or a computer system.

Still other objects, features and advantages of the present disclosure will become apparent by more detailed description on the basis of the examples of the present disclosure and the accompanying drawings described below. In the present specification, the system is a logical set of configurations of a plurality of devices, and the devices having each configuration are not limited to those in the same housing.

According to a configuration of an example of the present disclosure, a configuration in which an optimum system utterance is selected and output from a plurality of system utterances generated by a plurality of dialogue execution modules that generate system utterances in accordance with different algorithms is realized. Specifically, for example, a data processing unit generating and outputting system utterances selects one system utterance from among a plurality of system utterances individually generated by the plurality of dialogue execution modules and outputs the selected system utterance. Each of the plurality of dialogue execution modules generates algorithm-specific system utterances in accordance with different algorithms. The data processing unit selects one system utterance to be output in accordance with the degree of confidence which is set to correspond to a system utterance generated by each of the plurality of dialogue execution modules and a predefined dialogue execution module-compatible priority. According to the present configuration, a configuration in which an optimum system utterance is selected and output from a plurality of system utterances generated by a plurality of dialogue execution modules generating system utterances in accordance with different algorithms is realized.

Note that the effects described in the present specification are merely exemplary and not limited, and may have additional effects.

### BRIEF DESCRIPTION OF DRAWINGS

FIG. 1 is a diagram illustrating an example of specific processing of a dialogue robot that responds to a user utterance.

FIG. 2 is a diagram illustrating an example of specific processing of a dialogue robot that responds to a user utterance.

FIG. 3 is a diagram illustrating a configuration example of an information processing device of the present disclosure.

FIG. 4 is a diagram illustrating a configuration example of the information processing device of the present disclosure.

FIG. 5 is a diagram illustrating processing executed by the information processing device of the present disclosure.

FIG. 6 is a diagram illustrating processing executed by the information processing device of the present disclosure.

FIG. 7 is a diagram illustrating a configuration and processing of a processing determination unit (decision making unit) of the information processing device of the present disclosure.

FIG. 8 is a diagram illustrating a flowchart for describing a sequence of processing executed by the processing determination unit (decision making unit) of the information processing device of the present disclosure.

FIG. 9 is a diagram illustrating processing executed by a scenario-based dialogue execution module.

FIG. 10 is a diagram illustrating stored data of a scenario database referred to by the scenario-based dialogue execution module.

FIG. 11 is a diagram illustrating a flowchart for describing processing executed by the scenario-based dialogue execution module.

FIG. 12 is a diagram illustrating processing executed by an episode knowledge-based dialogue execution module.

FIG. 13 is a diagram illustrating stored data of an episode knowledge database referred to by the episode knowledge-based dialogue execution module.

FIG. 14 is a diagram illustrating a flowchart for describing processing executed by the episode knowledge-based dialogue execution module.

FIG. 15 is a diagram illustrating processing executed by an RDF knowledge-based dialogue execution module.

FIG. 16 is a diagram illustrating stored data of an RDF knowledge database referred to by the RDF knowledge-based dialogue execution module.

FIG. 17 is a diagram illustrating a flowchart for describing processing executed by the RDF knowledge-based dialogue execution module.

FIG. 18 is a diagram illustrating processing executed by a situation verbalization & RDF knowledge-based dialogue execution module.

FIG. 19 is a diagram illustrating a flowchart for describing processing executed by the situation verbalization & RDF knowledge-based dialogue execution module.

FIG. 20 is a diagram illustrating processing executed by a machine learning model-based dialogue execution module.

FIG. 21 is a diagram illustrating a flowchart for describing processing executed by the machine learning model-based dialogue execution module.

FIG. 22 is a diagram illustrating processing executed by an execution processing determination unit.

FIG. 23 is a diagram illustrating priority information corresponding to a dialogue execution module used by the execution processing determination unit.

FIG. 24 is a diagram illustrating a flowchart for describing processing executed by the execution processing determination unit.

FIG. 25 is a diagram illustrating a dialogue processing sequence executed by the information processing device of the present disclosure.

FIG. 26 is a diagram illustrating a dialogue processing sequence executed by the information processing device of the present disclosure.

FIG. 27 is a diagram illustrating an example of a hardware configuration of the information processing device.

### DESCRIPTION OF EMBODIMENTS

Hereinafter, an information processing device, an information processing system, an information processing method, and a program of the present disclosure will be described in detail with reference to the accompanying drawings. The description will be given in the following order.

1. Outline of dialogue processing based on speech recognition of user utterance which is executed by information processing device of the present disclosure

2. Configuration example of information processing device of the present disclosure

3. Example of specific configuration and example of specific processing of processing determination unit (decision making unit)

4. Details of processing in dialogue execution module (dialogue engine)

4-1. System utterance generation processing performed by scenario-based dialogue execution module

4-2. System utterance generation processing performed by episode knowledge-based dialogue execution module

4-3. System utterance generation processing performed by RDF knowledge-based dialogue execution module

4-4. System utterance generation processing performed by situation verbalization & RDF knowledge-based dialogue execution module

4-5. System utterance generation processing performed by machine learning model-based dialogue execution module

5. Details of processing executed by execution processing determination unit

6. Example of system utterance output performed by information processing device of the present disclosure

7. Hardware configuration example of information processing device

8. Summary of configuration of present disclosure

[1. Outline of Dialogue Processing Based on Speech Recognition of User Utterance which is Executed by Information Processing Device of the Present Disclosure]

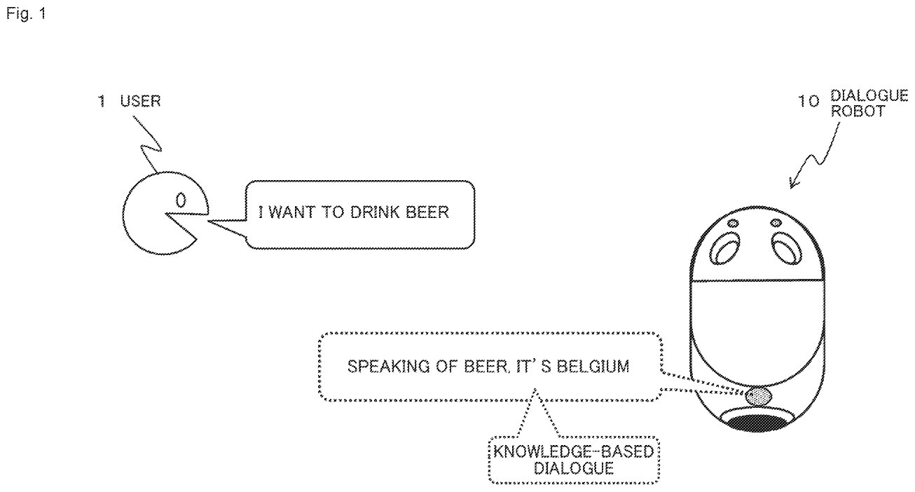

First, an outline of dialogue processing based on speech recognition of a user utterance which is executed by an information processing device of the present disclosure will be described with reference to FIG. 1 and the subsequent drawings.

FIG. 1 is a diagram illustrating an example of processing of a dialogue robot 10 which is an example of the information processing device of the present disclosure which recognizes a user utterance given by a user 1 and makes a response.

The dialogue robot 10 executes speech recognition processing of, for example, the following user utterance.

User utterance=“I want to drink beer.”

Note that data processing such as speech recognition processing may be executed by the dialogue robot 10 or may be executed by an external device that can communicate with the dialogue robot 10.

The dialogue robot 10 executes response processing based on a speech recognition result of a user utterance.

In the example illustrated in FIG. 1, data for responding to the user utterance=“I want to drink beer.” is acquired, a response is generated based on the acquired data, and the generated response is output through a speaker of the dialogue robot 10.

In the example illustrated in FIG. 1, the dialogue robot 10 performs the following system response.

System response=“Speaking of beer, it's Belgium.”

Note that, in the present specification, description will be given by referring an utterance given from a device such as a dialogue robot to as a “system utterance” or a “system response”.

The dialogue robot 10 generates and outputs a response using knowledge data acquired from a storage unit in the device or knowledge data acquired through a network.

That is, an optimum system response for a user utterance is generated and output with reference to a knowledge database.

In the example illustrated in FIG. 1, Belgium is registered as regional information of delicious beer in the knowledge database, and an optimum system response for a user utterance is generated and output with reference to the registered information of the knowledge database.

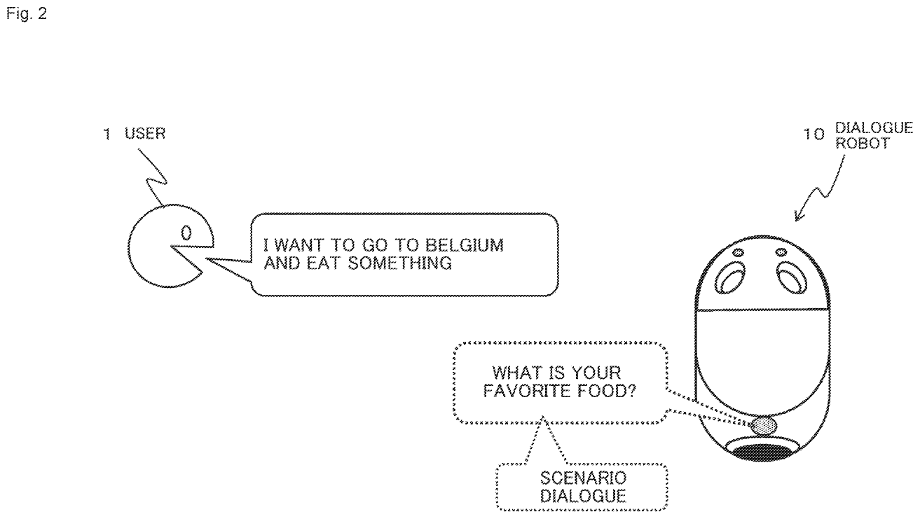

FIG. 2 illustrates the following user utterance.

User utterance=“I want to go to Belgium and eat something delicious.”

The dialogue robot 10 makes the following system response as a response to the user utterance.

System response=“What is your favorite food?”

The system response is not an optimum system response for a user utterance which is generated and output with reference to the knowledge database, unlike the system response of FIG. 1 described above.

The system response illustrated in FIG. 2 is response processing using a system response registered in a scenario database.

Optimum system utterance are registered in the scenario database in association with various corresponding user utterances, and the dialogue robot 10 retrieves registered data which is the same as or similar to a user utterance from the scenario database, acquires system response data recorded in the retrieved registered data, and outputs the acquired system response.

As a result, a system response as illustrated in FIG. 2 can be made.

In the dialogue processing of FIGS. 1 and 2, the dialogue robot 10 generates and outputs system responses by performing processing based on different algorithms. For example, FIG. 2 illustrates the following user utterance.

User utterance=“I want to go to Belgium and eat something delicious.”

Similarly to the processing illustrated in FIG. 1, with respect to the user utterance, a system utterance is generated with reference to a knowledge database, it is predicted that, for example, the following system utterance is generated.

System utterance=“Chocolate is delicious in Belgium.”

In this manner, when a generation algorithm for a system response executed on the dialogue robot 10 side is different, there is a possibility that the contents of responses to the same user utterance will be completely different.

In addition, when dialogue processing using only one response generation algorithm is performed, an optimum system response cannot be generated, and in some cases, a system utterance that is completely irrelevant to a user's utterance is given. Alternatively, in some cases, a system response cannot be made.

The present disclosure is contrived to solve such a problem, and optimum dialogues corresponding to various situations are realized by selectively using a plurality of different dialogue execution modules (dialogue engines).

That is, it is possible to perform an optimum system utterance by changing a response generation algorithm in accordance with a situation, such as response generation processing using a knowledge database as illustrated in FIG. 1, response generation processing using a scenario database as illustrated in FIG. 2, or the like.

[2. Configuration Example of Information Processing Device of the Present Disclosure]

Next, a configuration example of the information processing device of the present disclosure will be described.

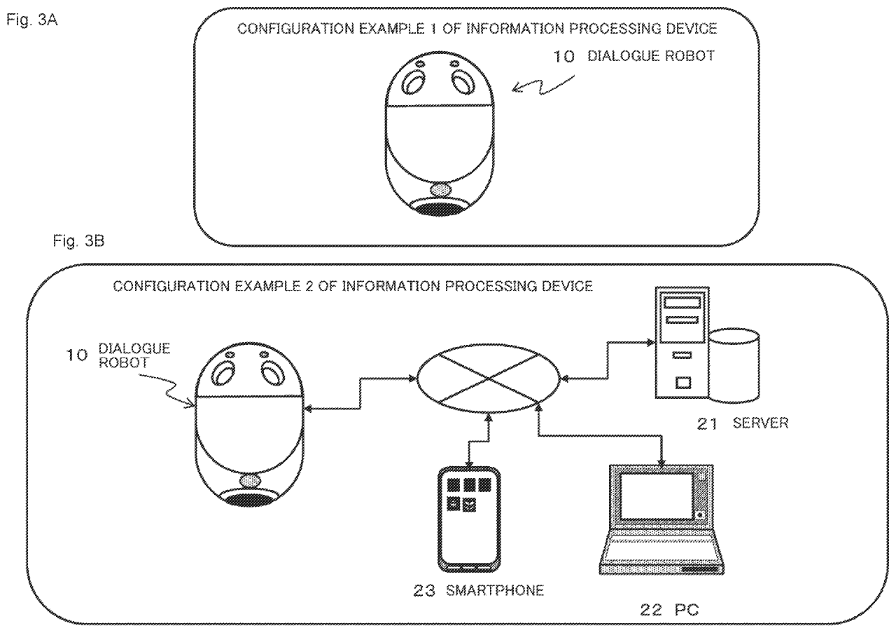

FIG. 3 is a diagram illustrating a configuration example of the information processing device of the present disclosure.

FIG. 3 illustrates the following two configuration examples of the information processing device.

(1) Configuration example 1 of the information processing device

(2) Configuration example 2 of the information processing device

Configuration example 1 of the information processing device of (1) shows a configuration of a single dialogue robot 10. The configuration is a configuration for executing all processing such as speech recognition processing of a user utterance and generation processing of a system utterance which is input through a microphone by the dialogue robot 10.

Configuration example 2 of the information processing device of (2) shows a device which is constituted by the dialogue robot 10 and an external device connected to the dialogue robot 10. The external device is, for example, a server 21, a PC 22, a smartphone 23, or the like.

In this configuration, the user utterance which is input through the microphone of the dialogue robot 10 is transferred to the external device, and the external device performs speech recognition of the user utterance. Further, the external device generates a system utterance based on a speech recognition result. The external device transmits the generated system utterance to the dialogue robot 10, and the dialogue robot 10 outputs the generated system utterance through a speaker.

Note that, in such a system configuration constituted by the dialogue robot 10 and the external device, various setting for distinguishing between processing executed on the dialogue robot 10 side and processing executed on the external device side can be performed.

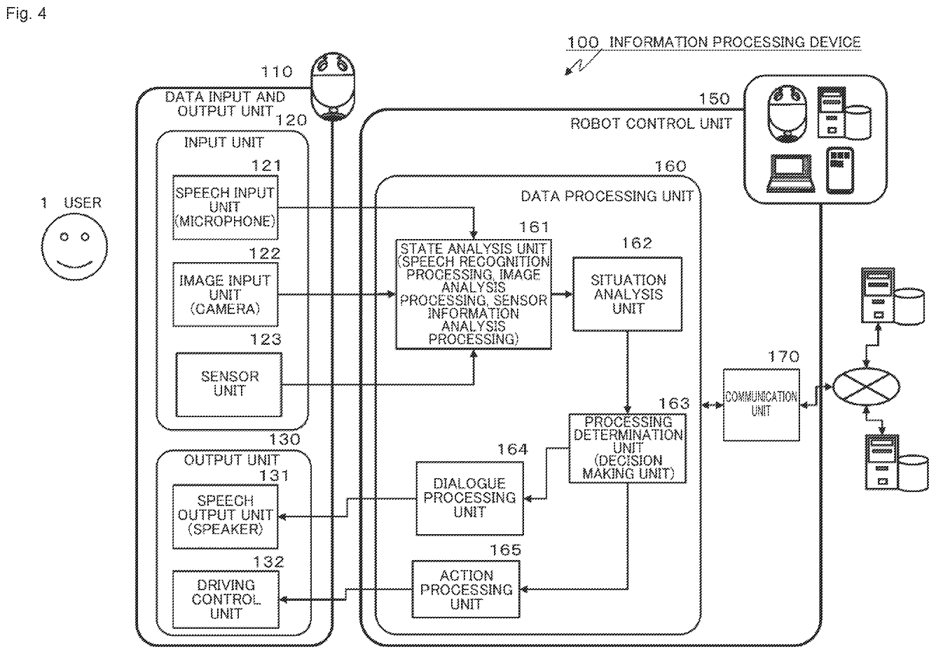

Next, an example of a specific configuration of the information processing device of the present disclosure will be described with reference to FIG. 4.

FIG. 4 is a diagram illustrating a configuration example of an information processing device 100 of the present disclosure.

The information processing device 100 is partitioned into a data input and output unit 110 and a robot control unit 150.

The data input and output unit 110 is a component which is configured in the dialogue robot illustrated in FIG. 1 and the like.

On the other hand, the robot control unit 150 is a component that can also be configured in the dialogue robot illustrated in FIG. 1 and the like, but can also be configured in an external device that can communicate with a robot. The external device is a device such as a server on a cloud, a PC, or a smartphone. The external device may be configured using one or a plurality of devices among these devices.

In a case where the data input and output unit 110 and the robot control unit 150 are different devices, the data input and output unit 110 and the robot control unit 150 include respective communication units and input and output data to and from each other through their communication units.

Note that FIG. 4 illustrates only main elements required to describe processing of the present disclosure. Each of the data input and output unit 110 and the robot control unit 150 includes, for example, a control unit controlling its execution processing, a storage unit storing various data, a user operation unit, a communication unit, and the like, but configurations thereof are not illustrated in the drawing.

Hereinafter, main components of the data input and output unit 110 and the robot control unit 150 will be described.

The data input and output unit 110 includes an input unit 120 and an output unit 130.

The input unit 120 includes a speech input unit (microphone) 121, an image input unit (camera) 122, and a sensor unit 123.

The output unit 130 includes a speech output unit (speaker) 131 and a driving control unit 132.

The speech input unit (microphone) 121 of the input unit 120 inputs a speech such as a user utterance.

The image input unit (camera) 122 captures an image such as a face image of a user.

The sensor unit 123 is constituted by any of various sensors such as a distance sensor, a temperature sensor, and an illuminance sensor.

Data acquired by the input unit 120 is input to a state analysis unit 161 in a data processing unit 160 of the robot control unit 150.

Note that, in a case where the data input and output unit 110 and the robot control unit 150 are constituted by different devices, data acquired by the input unit 120 is transmitted to the robot control unit 150 through the communication unit from the data input and output unit 110.

Next, the output unit 130 of the data input and output unit 110 will be described. The speech output unit (speaker) 131 of the output unit 130 outputs a system utterance generated by a dialogue processing unit 164 in the data processing unit 160 of the robot control unit 150.

The driving control unit 132 drives a dialogue robot. For example, the dialogue robot 10 illustrated in FIG. 1 includes a driving unit such as a tire and can move. For example, the dialogue robot 10 can perform moving processing such as approaching a user. Such driving processing such as movement is executed in response to a driving command received from an action processing unit 165 of the data processing unit 160 of the robot control unit 150.

Next, a configuration of the robot control unit 150 will be described.

As described above, the robot control unit 150 can also be configured in the dialogue robot 10 illustrated in FIG. 1 and the like, but can also be configured in an external device that can communicate with a robot.

The external device is a device such as a server on a cloud, a PC, or a smartphone. The external device may be configured using one or a plurality of devices among these devices.

The robot control unit 150 includes the data processing unit 160 and a communication unit 170. The communication unit 170 is configured to be able to communicate with an external server. The external server is a server that holds various databases that can be used to generate a system utterance, such as a knowledge database.

Note that, although not illustrated in the drawing, the robot control unit 150 also includes a control unit controlling processing of each unit of the robot control unit 150, a storage unit, a communication unit communicating with the data input and output unit 110, and the like, as described above.

The data processing unit 160 includes the state analysis unit 161, a situation analysis unit 162, a processing determination unit (decision making unit) 163, a dialogue processing unit 164, and an action processing unit 165.

The state analysis unit 161 inputs input information received from these input units 120, that is, the speech input unit (microphone) 121, the image input unit (camera) 122, and the sensor unit 123 of the input unit 120 of the data input and output unit 110 and executes state analysis based on the input information.

Specifically, a user utterance speech which is input through the speech input unit (microphone) 121 is analyzed. In addition, by analyzing image data which is input from the image input unit (camera) 122, user identification processing, user state analysis processing, and the like based on a user face image are executed.

Note that the state analysis unit 161 executes user identification processing based on a user face image with reference to a user DB in which a user face image has been registered in advance. The user DB is stored in an accessible storage unit of the data processing unit 160.

Further, the state analysis unit 161 analyzes states such as a distance from a user, the present temperature, and brightness, based on sensor information which is input from the sensor unit 123.

The state analysis unit 161 sequentially analyzes acquired information of input unit components, that is, the speech input unit (microphone) 121, the image input unit (camera) 122, and the sensor unit 123 of the input unit 120 and outputs the analyzed state information to the situation analysis unit 152.

That is, the state analysis unit 161 outputs time-series state information, that is, a state acquired at time t1, a state acquired at time t2, and a state acquired at time t3 to the situation analysis unit 152 at any time.

The state analysis unit 161 outputs, for example, state information given a time stamp indicating state information acquisition time to the situation analysis unit 152 at any time.

The state information analyzed by the state analysis unit 161 includes information indicating states such as the state of the host device, the state of a person, the state of a thing, and the state of a place.

The state information of the host device includes various state information such as information indicating that the host device, that is, the dialogue robot including the data input and output unit 110 is being charged, an action that is executed last, a remaining amount of battery, the temperature of the device, falling, walking, and the current emotional state.

State information of a person includes state information such as the name of a person included in a camera-captured image, a person's facial expression, a person's position, an angle, speaking, not speaking, and a person's utterance text.

State information of a thing includes information such as an identification result of a thing included in a camera-captured image, the time when the last thing is recognized, and a place (angle, distance), and the like.

State information of a place includes information such as the brightness of the place, temperature, and whether the place is located indoor or outdoor.

The state analysis unit 161 sequentially generates state information constituted by the various information based on information acquired by the speech input unit (microphone) 121, the image input unit (camera) 122, and the sensor unit 123 and outputs the generated state information to the situation analysis unit 152 together with a time stamp indicating time information when information is acquired.

The situation analysis unit 162 generates situation information based on state information in units of times which is sequentially input from the state analysis unit 161 and outputs the generated situation information to the processing determination unit (decision making unit) 163.

Note that the situation analysis unit 162 generates situation information having a data format in which the dialogue execution module (dialogue engine) in the processing determination unit (decision making unit) 163 can analyze the situation information.

The situation analysis unit 162 executes, for example, speech recognition processing of a user utterance which is input through the state analysis unit 161 from the speech input unit (microphone) 121.

Note that speech recognition processing of a user utterance in the situation analysis unit 162 includes processing for converting speech data into text data by applying, for example, automatic speech recognition (ASR) or the like, and the like.

The processing determination unit (decision making unit) 163 executes processing for selecting one system utterance from among system utterances generated by a plurality of dialogue execution modules (dialogue engines) that generate system utterances corresponding to a plurality of different algorithms, and the like.

Each of the plurality of dialogue execution modules (dialogue engines) that generate system utterances corresponding to a plurality of different algorithms generates a system utterance based on situation information generated by the situation analysis unit 162.

Note that the plurality of dialogue execution modules (dialogue engines) may be configured inside the processing determination unit (decision making unit) 163 or may be configured in an external server.

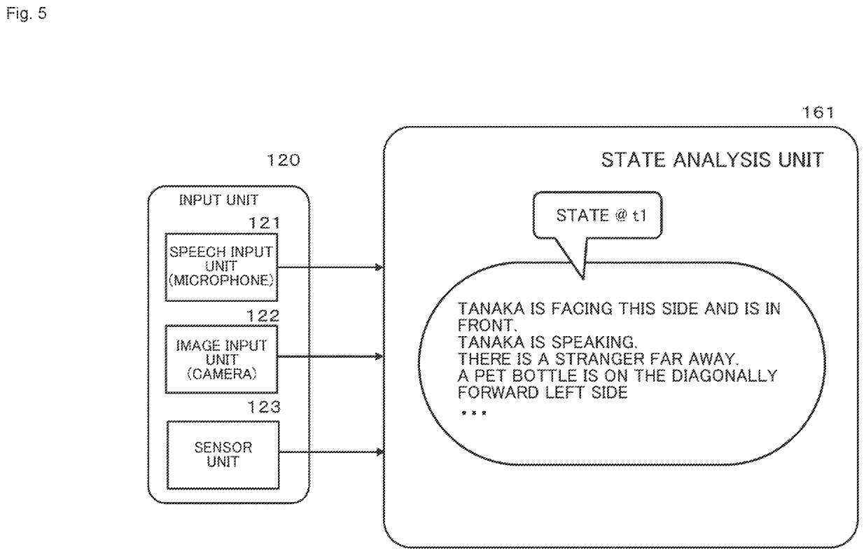

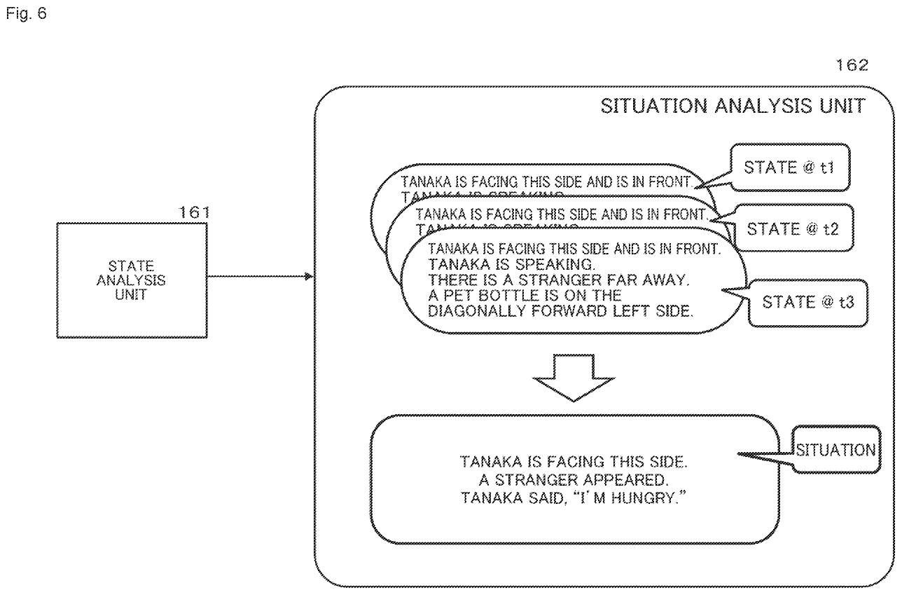

Specific examples of processing executed by the state analysis unit 161 and the situation analysis unit 162 will be described with reference to FIGS. 5 and 6. FIG. 5 illustrates an example of state information at a certain time t1 which is generated by the state analysis unit 161.

That is, the state analysis unit 161 inputs information acquired by the input unit components, that is, the speech input unit (microphone) 121, the image input unit (camera) 122, and the sensor unit 123 of the input unit 120 of the data input and output unit 110 at time t1 and generates the following state information based on the input information.

State information=“Tanaka is facing this side and is in front. Tanaka is speaking. There is a stranger far away. A plastic bottle is on the diagonally forward left side . . . .”

The state analysis unit 161 generates, for example, such state information.

The state information generated by the state analysis unit 161 is sequentially input to the situation analysis unit 162 together with a time stamp.

An example of specific processing of the situation analysis unit 162 will be described with reference to FIG. 6. The situation analysis unit 162 generates situation information based on a plurality of pieces of state information generated by the state analysis unit 161, that is, time-series state information. For example, the following situation information as illustrated in FIG. 6 is generated.

Situation information=“Tanaka is facing this side. A stranger appeared. Tanaka said, “I'm hungry”.”

The situation information generated by the situation analysis unit 162 is output to the processing determination unit (decision making unit) 163.

The processing determination unit (decision making unit) 163 transfers the situation information to the plurality of dialogue execution modules (dialogue engines) that generate system utterances corresponding to a plurality of different algorithms.

Each of the plurality of dialogue execution modules (dialogue engines) executes a system utterance generation algorithm specific to each module based on the situation information generated by the situation analysis unit 162 to individually generate a system utterance.

The processing determination unit (decision making unit) 163 selects one system utterance to be output, from among the plurality of system utterances generated by the plurality of dialogue execution modules (dialogue engines).

Although system utterances generated by the plurality of dialogue execution modules (dialogue engines) by applying different algorithms are different utterances, the processing determination unit (decision making unit) 163 executes processing for selecting one system utterance to be output from among the plurality of system utterances, and the like.

Specific examples of system utterance generation processing and system utterance selection processing executed by the processing determination unit (decision making unit) 163 will be described later in detail.

Further, the processing determination unit (decision making unit) 163 also generates not only a system utterance but also an action of a robot device, that is, driving control information.

A system utterance determined by the processing determination unit (decision making unit) 163 is output to the dialogue processing unit 164.

In addition, a robot device action determined by the processing determination unit (decision making unit) 163 is output to the action processing unit 165.

The dialogue processing unit 164 generates utterance text based on the system utterance determined by the processing determination unit (decision making unit) 163 and outputs a system utterance by controlling the speech output unit (speaker) 131 of the output unit 130.

On the other hand, the action processing unit 165 generates driving information based on the robot device action determined by the processing determination unit (decision making unit) 163 and drives the robot by controlling the driving control unit 132 of the output unit 130.

[3. Example of Specific Configuration and Example of Specific Processing of Processing Determination Unit (Decision Making Unit)]

Next, an example of a specific configuration and an example of specific processing of the processing determination unit (decision making unit) 163 will be described.

As described above, the processing determination unit (decision making unit) 163 selects one system utterance to be output, from among a plurality of system utterances generated by the plurality of dialogue execution modules (dialogue engines).

Each of the plurality of dialogue execution modules (dialogue engines) generating system utterances corresponding to a plurality of different algorithms generates a system utterance to be executed next, based on situation information generated by the situation analysis unit 162, and specifically, for example, a user utterance includes in the situation information.

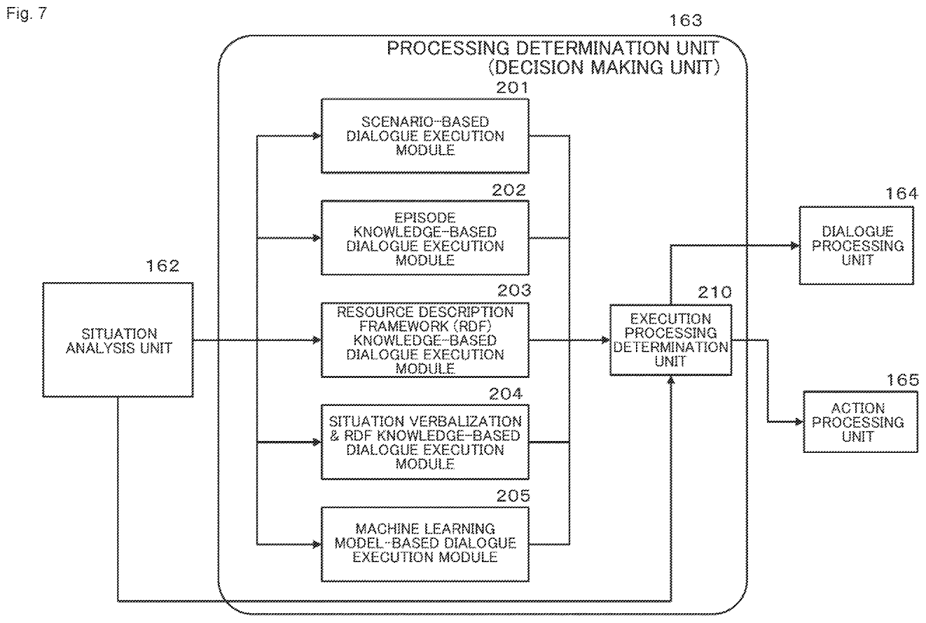

FIG. 7 illustrates an example of a specific configuration of the processing determination unit (decision making unit) 163.

The example illustrated in FIG. 7 is a configuration example in which the following five dialogue execution modules (dialogue engines) are included in the processing determination unit (decision making unit) 163.

(1) A scenario-based dialogue execution module 201

(2) An episode knowledge-based dialogue execution module 202

(3) A resource description framework (RDF) knowledge-based dialogue execution module 203

(4) A situation verbalization & RDF knowledge-based dialogue execution module 204

(5) A machine learning model-based dialogue execution module 205

These five dialogue execution modules (dialogue engines) execute parallel processing to generate system responses by different algorithms.

Note that FIG. 7 illustrates an example in which five dialogue execution modules (dialogue engines) 201 to 205 are configured in the processing determination unit (decision making unit) 163, but these five dialogue execution modules (dialogue engines) 201 to 205 may be individually configured in an external device such as an external server.

In this case, the processing determination unit (decision making unit) 163 communicates with an external device such as an external server through the communication unit 170. The processing determination unit (decision making unit) 163 transmits situation information generated by the situation analysis unit 162, and specifically, situation information such as a user utterance included in the situation information to an external device such as an external server through the communication unit 170.

The dialogue execution module (dialogue engine) in the external device such as an external server generates a system utterance in accordance with an algorithm specific to each module based on the received situation information such as a user utterance, and transmits the generated system utterance to the processing determination unit (decision making unit) 163.

The system utterances generated by the five dialogue execution modules (dialogue engines) 201 to 205 configured in the processing determination unit (decision making unit) 163 or the external device are input to the execution processing determination unit 210 in the processing determination unit (decision making unit) 163 illustrated in FIG. 7.

The execution processing determination unit 210 inputs the system utterances generated by five modules and selects one system utterance to be output, from among the input system utterances.

The selected system utterance is output to the dialogue processing unit 164, is converted into text, and is output through the speech output unit (speaker) 131.

Note that the five modules 201 to 205 perform system utterance generation processing in accordance with the respective algorithms, but all of the modules do not necessarily succeed in generating a system utterance. For example, all of the five modules may fail in generating a system utterance. In such a case, the execution processing determination unit 210 determines an action of a robot and outputs the determined action to the action processing unit 165.

The action processing unit 165 generates driving information based on the robot device action determined by the processing determination unit (decision making unit) 163 and controls the driving control unit 132 of the output unit 130 to drive the robot.

Note that situation information generated by the situation analysis unit 162 may be directly input to the processing determination unit (decision making unit) 163, and an action of the robot may be determined based on the situation information, for example, situation information other than a user utterance.

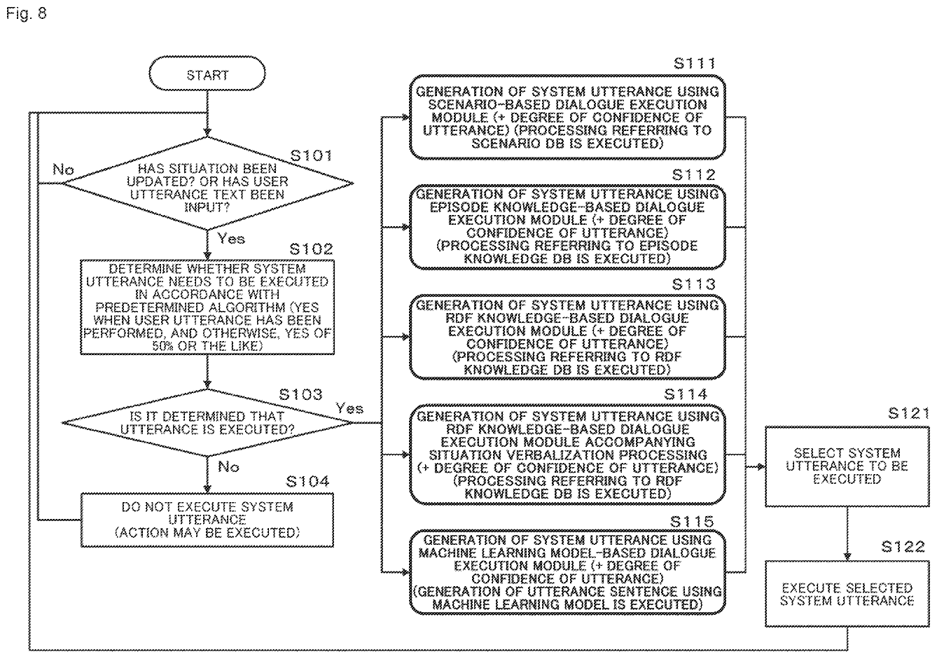

Next, a processing sequence of processing executed by the processing determination unit (decision making unit) 163 will be described with reference to FIG. 8.

FIG. 8 is a diagram illustrating a flowchart for describing a sequence of processing executed by the processing determination unit (decision making unit) 163.

Processing according to processing the flow can be executed in accordance with a program stored in the storage unit of the robot control unit 150 of the information processing device 100, and can be executed under the control of a control unit (data processing unit) including a processor such as a CPU having a program execution function.

Hereinafter, processes of each step of the flow illustrated in FIG. 8 will be described.

(Step S101)

First, in step S101, the processing determination unit (decision making unit) 163 determines whether a situation has been updated or whether user utterance text has been input.

Specifically, it is determined whether new situation information or user utterance has been input to the processing determination unit (decision making unit) 163 from the situation analysis unit 162.

In a case where it is determined that new situation information or user utterance has not been input to the processing determination unit (decision making unit) 163 from the situation analysis unit 162, the processing stays in step S101.

In a case where it is determined that new situation information or user utterance has been input to the processing determination unit (decision making unit) 163 from the situation analysis unit 162, the processing proceeds to step S102.

(Step S102)

In a case where it is determined that new situation information or user utterance has been input to the processing determination unit (decision making unit) 163 from the situation analysis unit 162, the processing determination unit (decision making unit) 163 determines in step S102 whether a system utterance needs to be executed in accordance with a predetermined algorithm.

Specifically, the predetermined algorithm is an algorithm for executing a system utterance, for example, in a case where a user utterance has been input, and executing a system utterance once every two times in a case where a user utterance has not been input, that is, in a case where only a situation has changed.

(Step S103)

In the system utterance execution necessity determination processing in step S102, in a case where it is determined that a system utterance is executed, processes of steps S111 to S115 are executed in parallel.

The processes of steps S111 to S115 are system utterance generation processing using different dialogue execution modules (dialogue engines).

On the other hand, in the system utterance execution necessity determination processing in step S102, in a case where it is determined that a system utterance is not executed, the process of step S104 is executed.

(Step S104)

In the system utterance execution necessity determination processing in step S102, in a case where it is determined that a system utterance is not executed, the processing proceeds to step S104, and a system utterance is not output.

Note that, in this case, the processing determination unit (decision making unit) 163 may output an instruction to the action processing unit 165 so as to cause the dialogue robot to execute an action such as moving processing.

(Steps S111 to S115)

In the system utterance execution necessity determination processing in step S102, in a case where it is determined that a system utterance is executed, the processes of steps S111 to S115 are executed in parallel.

As described above, the processes of steps S111 to S115 are system utterance generation processing using different dialogue execution modules (dialogue engines).

In steps S111 to S115, the following five processes are executed in parallel.

(S111) Generation of a system utterance using the scenario-based dialogue execution module (+the degree of confidence of an utterance) (processing referring to a scenario DB is executed)

(S112) Generation of a system utterance using the episode knowledge-based dialogue execution module (+the degree of confidence of an utterance) (processing referring to an episode knowledge DB is executed)

(S113) Generation of a system utterance using the RDF knowledge-based dialogue execution module (+the degree of confidence of an utterance) (processing referring to an RDF knowledge DB is executed)

(S114) Generation of a system utterance using the RDF knowledge-based dialogue execution module accompanying situation verbalization processing (+the degree of confidence of an utterance) (processing referring to the RDF knowledge DB is executed)

(S115) Generation of a system utterance using the machine learning model-based dialogue execution module (+the degree of confidence of an utterance) (processing referring to a machine learning model is executed)

These five processes are system utterance generation processing using the different dialogue execution modules (dialogue engines) 201 to 205.

As described above, the processing performed using these five dialogue execution modules (dialogue engines) 201 to 205 may be executed in the data processing unit 160 of the robot control unit 150 illustrated in FIG. 4, or may be executed using an external device such as an external server connected through the communication unit 170.

Details of the five processes executed by the dialogue execution modules (dialogue engines) 201 to 205 will be described later.

In steps S111 to 115, system utterance generation processing to which different algorithms using five different dialogue execution modules (dialogue engines) 201 to 205 are applied is executed.

Although the dialogue execution modules (dialogue engines) generate system utterances corresponding the same one piece of situation information, for example, the same one user utterance, the algorithms thereof are different from each other, and thus the modules generate different system utterances. In addition, some modules may fail in generating a system utterance.

The five dialogue execution modules (dialogue engines) also generate the value of the degree of confidence which is an index value indicating the degree of confidence of the generated system utterance at the time of the generation of a system utterance in steps S111 to S115, and output the generated value to the execution processing determination unit 210.

The dialogue execution modules (dialogue engines) output the degree of confidence=1.0, for example, in a case where the generation of a system utterance has been successful, and output the degree of confidence=0.0 in a case where the generation of a system utterance has not been successful.

However, in the case of utterances repeated many times in the past, or when the accuracy of a created system utterance sentence is low, or the like, settings for outputting the value of the degree of confidence=0.0 to 1.0, for example, the value of 0.5 or the like may be performed.

(Step S121)

After the processes of steps S111 to S115 are performed, the execution processing determination unit 210 of the processing determination unit (decision making unit) 163 illustrated in FIG. 7 inputs a plurality of different system utterances generated based on different algorithms from the plurality of dialogue execution modules (dialogue engines) 201 to 205.

In step S121, the execution processing determination unit 210 selects one system utterance having the largest value of the degree of confidence from among the plurality of system utterances that are input from the plurality of dialogue execution modules (dialogue engines) and sets the system utterance to be output by the dialogue robot.

Note that, in a case where the values of the degrees of confidence that are input from the plurality of dialogue execution modules (dialogue engines) are the same, a system utterance to be output by the dialogue robot is determined in accordance with preset priorities in units of dialogue execution modules (dialogue engines). Details of this processing will be described later.

Note that the dialogue execution modules (dialogue engines) 201 to 205 may be configured to output only a system utterance and not to output the value of the degree of confidence.

In the case of this configuration, the following processing is executed on the execution processing determination unit 210 side.

In a case where a system utterance has been input from the dialogue execution module (dialogue engine), the degree of confidence of the system utterance is set to 1.0, and in a case where a system utterance has not been input from the dialogue execution module (dialogue engine), the degree of confidence of the system utterance is set to 0.0.

In step S121, the execution processing determination unit 210 selects one system utterance from among the plurality of system utterances that are input from the plurality of dialogue execution modules (dialogue engines) as a system utterance to be output.

This selection processing is executed in consideration of the values of the degrees of confidence associated with the system utterances generated by the modules and the preset priorities of the modules.

Details of this processing will be described later.

(Step S122)

Finally, in step S122, the processing determination unit (decision making unit) 163 outputs one system utterance selected in step S121 from the dialogue robot.

Specifically, the system utterance determined by the processing determination unit (decision making unit) 163 is output to the dialogue processing unit 164. The dialogue processing unit 164 generates utterance text based on the input system utterance and outputs the generated utterance text by controlling the speech output unit (speaker) 131 of the output unit 130.

[4. Details of Processing in Dialogue Execution Module (Dialogue Engine)]

Next, details of the system utterance generation processing using different dialogue execution modules (dialogue engines) 201 to 205 which is executed in steps S111 to S115 of the flow illustrated in FIG. 8 will be described.

Note that, as described above, in steps S111 to S115 of the flow illustrated in FIG. 8, the following five processes are executed in parallel.

(S111) Generation of a system utterance using the scenario-based dialogue execution module 201 (+the degree of confidence of an utterance) (processing referring to a scenario DB is executed)

(S112) Generation of a system utterance using the episode knowledge-based dialogue execution module 202 (+the degree of confidence of an utterance) (processing referring to an episode knowledge DB is executed)

(S113) Generation of a system utterance using the RDF knowledge-based dialogue execution module 203 (+the degree of confidence of an utterance) (processing referring to an RDF knowledge DB is executed)

(S114) Generation of a system utterance using the RDF knowledge-based dialogue execution module 204 accompanying situation verbalization processing (+the degree of confidence of an utterance) (processing referring to the RDF knowledge DB is executed)

(S115) Generation of a system utterance using the machine learning model-based dialogue execution module 205 (+the degree of confidence of an utterance) (processing referring to a machine learning model is executed)

As described above, these five processes may be executed in the data processing unit 160 of the robot control unit 150 illustrated in FIG. 4 or may be executed by an external device such as an external server connected through the communication unit 170.

For example, a configuration may be adopted in which five external servers execute five processes of steps S111 to S115, and the processing determination unit (decision making unit) 163 in the data processing unit 160 of the robot control unit 150 illustrated in FIG. 4 receives processing results.

Hereinafter, details of the processing executed by these five dialogue execution modules (dialogue engines) 201 to 205 will be sequentially described.

(4-1. System Utterance Generation Processing Performed by Scenario-Based Dialogue Execution Module)

First, the system utterance generation processing using the scenario-based dialogue execution module 201 which is executed in step S111 of the flow illustrated in FIG. 8 will be described.

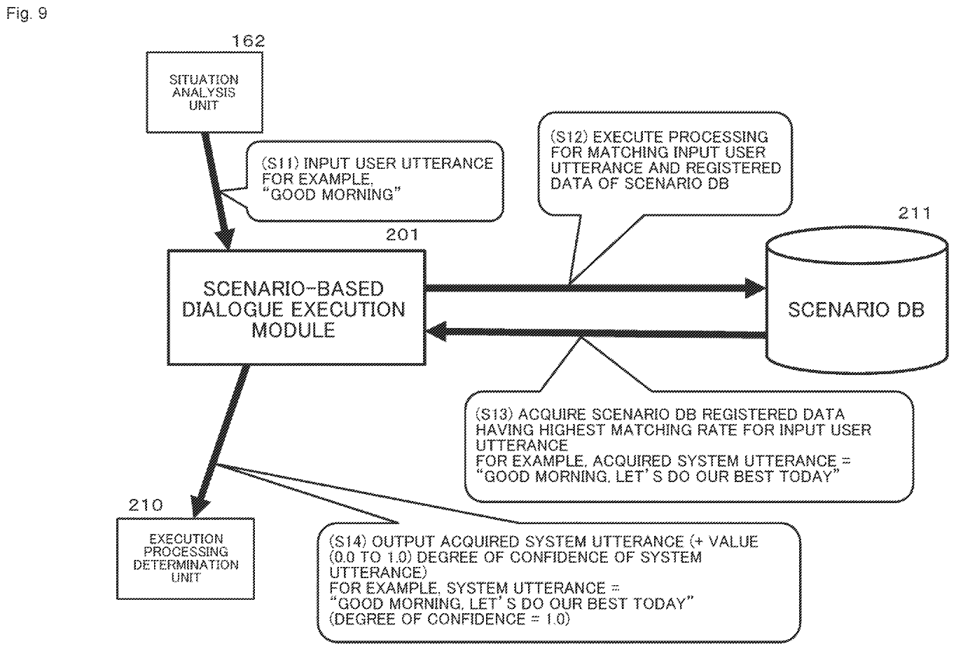

Details of the system utterance generation processing using the scenario-based dialogue execution module 201 will be described with reference to FIG. 9.

FIG. 9 illustrates the scenario-based dialogue execution module 201. The scenario-based dialogue execution module 201 generates a system utterance with reference to scenario data stored in the scenario DB (database) 211 illustrated in FIG. 9. The scenario DB (database) 211 is a database which is installed in the robot control unit 150 or in an external device such as an external server.

Note that the scenario-based dialogue execution module 201 and the scenario DB (database) 211 may be configured in the robot control unit 150 of the information processing device 100 illustrated in FIG. 4, but may be configured to be provided in an external server that can communicate with the information processing device 100.

The scenario-based dialogue execution module 201 executes processing in the order of steps S11 to S14 illustrated in FIG. 9. That is, the scenario-based system utterance generation algorithm is executed to generate a scenario-based system utterance.

First, in step S11, a user utterance is input from the situation analysis unit 162. For example, the following user utterance is input.

User utterance=“Good morning.”

Next, in step S12, the scenario-based dialogue execution module 201 executes processing for matching the input user utterance and scenario DB registered data.

The scenario DB (database) 211 is a database in which utterance set data including user utterances corresponding to various dialogue scenarios and system utterances is registered.

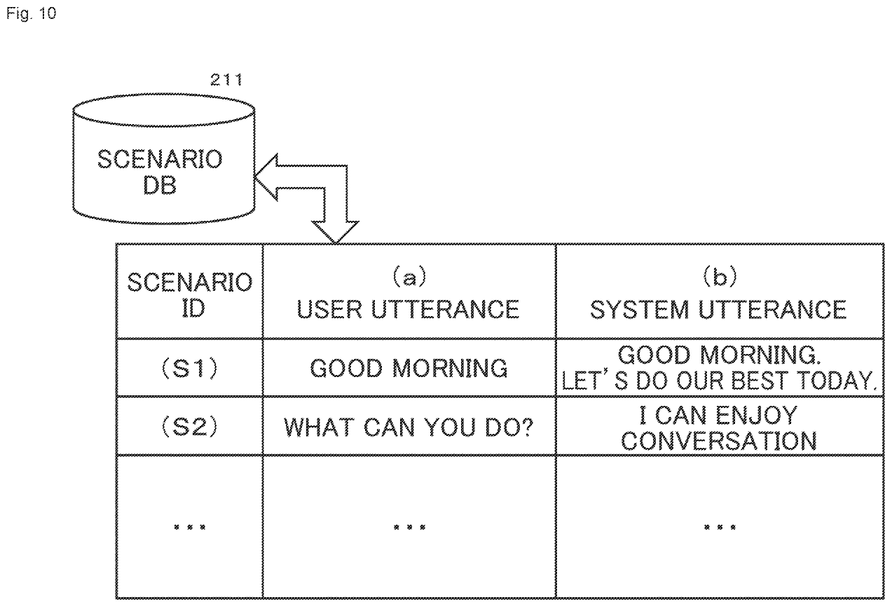

A specific example of registered data of the scenario DB (database) 211 is illustrated in FIG. 10.

As illustrated in FIG. 10, in the scenario DB (database) 211, utterance set data including user utterances and system utterances is registered for each of various dialogue scenarios (scenario ID=1, 2, . . . ).

An optimum system utterance to be executed by the dialogue robot (system) in accordance with a certain user utterance is registered in each entry.

The scenario DB is a database in which optimum system utterances corresponding to user utterances in accordance with various dialogue scenarios are registered in advance.

In step S12, the scenario-based dialogue execution module 201 executes retrieval processing regarding whether a user utterance which is the same as or similar to the input user utterance has not been registered in the scenario DB, that is, processing for matching the input user utterance and the DB registered data.

Next, in step S13, the scenario-based dialogue execution module 201 acquires scenario DB registered data having the highest matching rate for the input user utterance.

In the scenario DB (database) 211 illustrated in FIG. 10, User utterance=Good morning/System utterance=Good morning. Let's do our best today is registered as registered data of scenario ID=(S1).

In step S13, the scenario-based dialogue execution module 201 acquires registered data of the database.

That is, the following system utterance is acquired from the scenario DB (database) 211.

System utterance=“Good morning. Let's do our best today.”

Next, in step S14, the scenario-based dialogue execution module 201 outputs the system utterance acquired from the scenario DB (database) 211 to the execution processing determination unit 210 illustrated in FIG. 7.

Note that a configuration may be adopted in which the scenario-based dialogue execution module 201 generates the value of the degree of confidence which is an index value indicating the degree of confidence of an output system utterance, for example, the degree of confidence=0.0 to 1.0 at the time of outputting the system utterance and outputs the generated value of the degree of confidence to the execution processing determination unit 210 together with the system utterance. For example, the degree of confidence=1.0 is output in a case where the generation of a system utterance has been successful, and the degree of confidence=0.0 is output in a case where the generation of a system utterance has not been successful. Note that, as described above, a configuration can also be adopted in which the dialogue execution modules (dialogue engines) output only a system utterance and do not output the value of the degree of confidence.

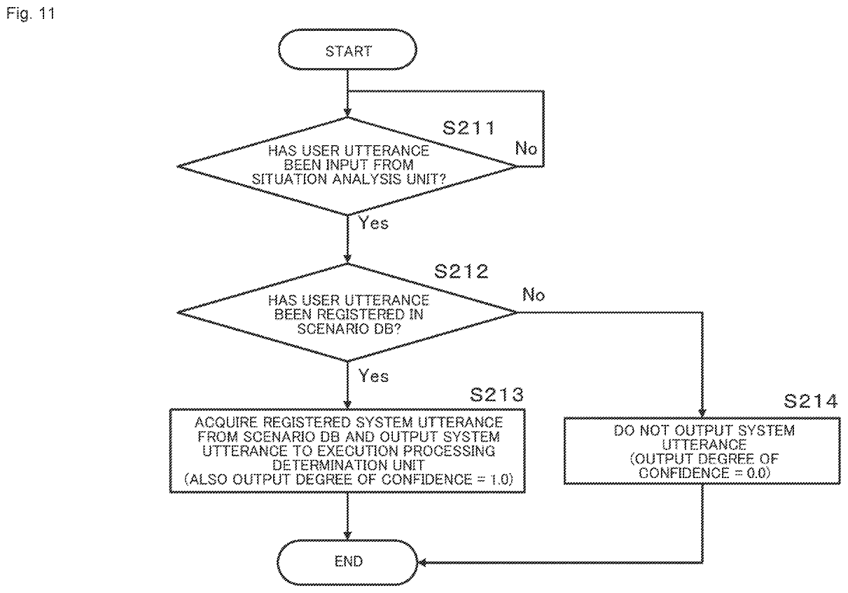

Next, a processing sequence executed by the scenario-based dialogue execution module 201 will be described with reference to a flowchart illustrated in FIG. 11. Processing of each step in the flow illustrated in FIG. 11 will be sequentially described.

(Step S211)

First, in step S211, it is determined whether a user utterance has been input from the situation analysis unit 162, and in a case where it is determined that a user utterance has been input, the processing proceeds to step S212.

(Step S212)

Next, in step S212, the scenario-based dialogue execution module 201 determines whether user utterance data which is the same as or similar to the input user utterance has been registered in the scenario DB 211.

As described above with reference to FIG. 10, the scenario DB (database) 211 is a database in which utterance set data including user utterances corresponding to various dialogue scenarios and system utterances is registered.

In step S212, the scenario-based dialogue execution module 201 executes retrieval processing regarding whether a user utterance which is the same as or similar to the input user utterance has not been registered in the scenario DB 211, that is, processing for matching the input user utterance and the DB registered data.

In a case where it is determined that a user utterance which is the same as or similar to the input user utterance has been registered in the scenario DB 211, the processing proceeds to step S213.

In a case where it is determined that a user utterance which is the same as or similar to the input user utterance has not been registered in the scenario DB 211, the processing proceeds to step S214.

(Step S213)

In a case where it is determined in step S212 that a user utterance which is the same as or similar to the input user utterance has been registered in the scenario DB 211, the processing proceeds to step S213.

In step S213, the scenario-based dialogue execution module 201 acquires a system utterance recorded to correspond to a user utterance registered in the scenario DB having the highest matching rate for the input user utterance from the scenario DB 211, and outputs the acquired system utterance to the execution processing determination unit 210 illustrated in FIG. 7.

Note that the value of the degree of confidence which is an index value indicating the degree of confidence of the acquired system utterance may also be output to the execution processing determination unit 210 together with the output of the system utterance. In this case, the generation (acquisition) of a system utterance has been successful, and thus the value of the degree of confidence=1.0 is output.

(Step S214)

On the other hand, in a case where it is determined in step S212 that a user utterance which is the same as or similar to the input user utterance has not been registered in the scenario DB 211, the processing proceeds to step S214.

In step S214, the scenario-based dialogue execution module 201 does not execute the output of a system utterance to the execution processing determination unit 210.

Note that, in a case where the value of the degree of confidence which is an index value indicating the degree of confidence of the system utterance is output, the generation (acquisition) of a system utterance has not been successful, and thus the value of the degree of confidence=0.0 is output to the execution processing determination unit 210.

(4-2. System Utterance Generation Processing Performed by Episode Knowledge-Based Dialogue Execution Module)

Next, the system utterance generation processing using the episode knowledge-based dialogue execution module 202 which is executed in step S112 of the flow illustrated in FIG. 8 will be described.

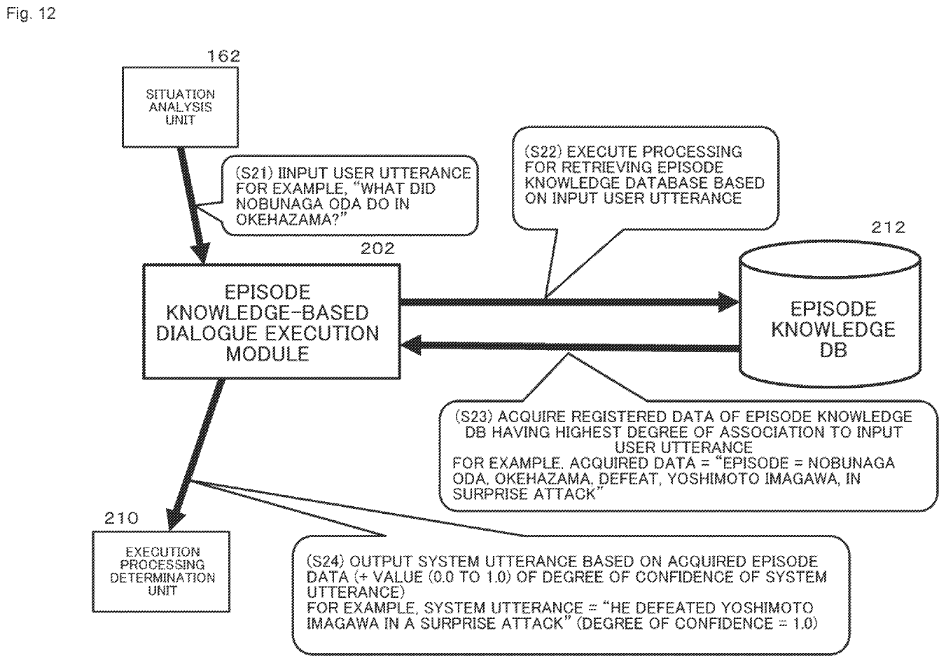

Details of the system utterance generation processing using the episode knowledge-based dialogue execution module 202 will be described with reference to FIG. 12. FIG. 12 illustrates the episode knowledge-based dialogue execution module 202. The episode knowledge-based dialogue execution module 202 generates a system utterance with reference to episode knowledge data stored in the episode knowledge DB (database) 212 illustrated in FIG. 12.

The episode knowledge DB (database) 212 is a database which is installed in the robot control unit 150 or in an external device such as an external server.

Note that the episode knowledge-based dialogue execution module 202 and the episode knowledge DB (database) 212 may be configured in the robot control unit 150 of the information processing device 100 illustrated in FIG. 4, but may be configured to be provided in an external server that can communicate with the information processing device 100.

The episode knowledge-based dialogue execution module 202 executes processing in the order of steps S21 to S24 illustrated in FIG. 12. That is, an episode knowledge-based system utterance is generated by executing an episode knowledge-based system utterance generation algorithm.

First, in step S21, a user utterance is input from the situation analysis unit 162. For example, the following user utterance is input.

User utterance=“What did Nobunaga Oda do in Okehazama?”

Next, in step S22, the episode knowledge-based dialogue execution module 202 executes processing for retrieving registered data of the episode knowledge DB 212 based on the input user utterance.

The episode knowledge DB (database) 212 is a database in which various episodes, for example, various episode information such as historical facts, news, and user-related surrounding events are recorded. Note that the episode knowledge DB 212 is sequentially updated. For example, the episode knowledge DB 212 is updated based on information which is input through the input unit 120 of the data input and output unit 120 of the dialogue robot.

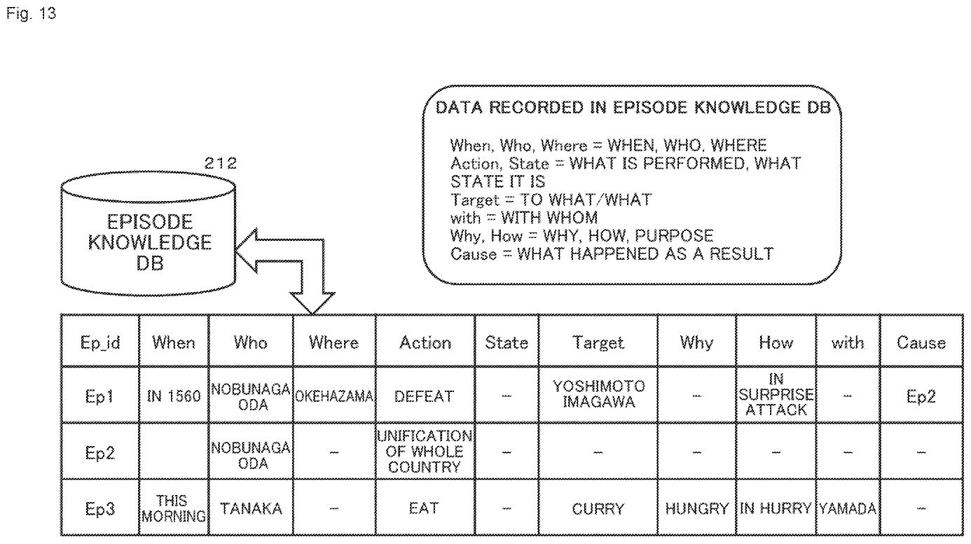

A specific example of registered data of the episode knowledge DB (database) 212 is illustrated in FIG. 13.

As illustrated in FIG. 13, data indicating details of an episode is recorded for each of various dialogue episodes (episode ID (Ep_id)=1, 2, . . . ) in the episode knowledge DB (database) 212.

Specifically, the following information is recorded in units of episodes.

When, Who, Where=when, where, who

Action, State=what is performed, what state it is

Target=to what/what

with=with whom

Why, How=why, how, purpose

Cause=what happened as a result

A database in which these information is recorded in units of episodes is the episode knowledge DB (database) 212.

By referring to the registered information of the episode knowledge DB (database) 212, detailed information on various episodes can be known.

In step S22, the episode knowledge-based dialogue execution module 202 executes processing for retrieving the registered data of the episode knowledge DB based on the input user utterance.

Processing in a case where the following user utterance is input will be described.

User utterance=“What did Nobunaga Oda do in Okehazama?”

In this case, in step S23, the episode knowledge-based dialogue execution module 202 extracts an entry of an episode ID (Ep_id)=Ep1 from the registered data of the episode knowledge DB illustrated in FIG. 13 as an episode including the most words and phrases that are the same as words and phrases included in a user's utterance.

Next, in step S24, the episode knowledge-based dialogue execution module 202 generates a system utterance based on episode detailed information included in the entry of the episode ID (Ep_id)=Ep1 acquired from the episode knowledge DB (database) 212 and outputs the generated system utterance to the execution processing determination unit 210 illustrated in FIG. 7.

For example, the following system utterance is generated and output to the execution processing determination unit 210.

System utterance=“He defeated Yoshimoto Imagawa in a surprise attack.”

Note that a configuration may be adopted in which the episode knowledge-based dialogue execution module 202 generates the value of the degree of confidence which is an index value indicating the degree of confidence of an output system utterance, for example, the degree of confidence=0.0 to 1.0 at the time of outputting the system utterance and outputs the generated value of the degree of confidence to the execution processing determination unit 210 together with the system utterance.

For example, the degree of confidence=1.0 is output in a case where the generation of a system utterance has been successful, and the degree of confidence=0.0 is output in a case where the generation of a system utterance has not been successful. Note that, as described above, a configuration can also be adopted in which the dialogue execution modules (dialogue engines) output only a system utterance and do not output the value of the degree of confidence.

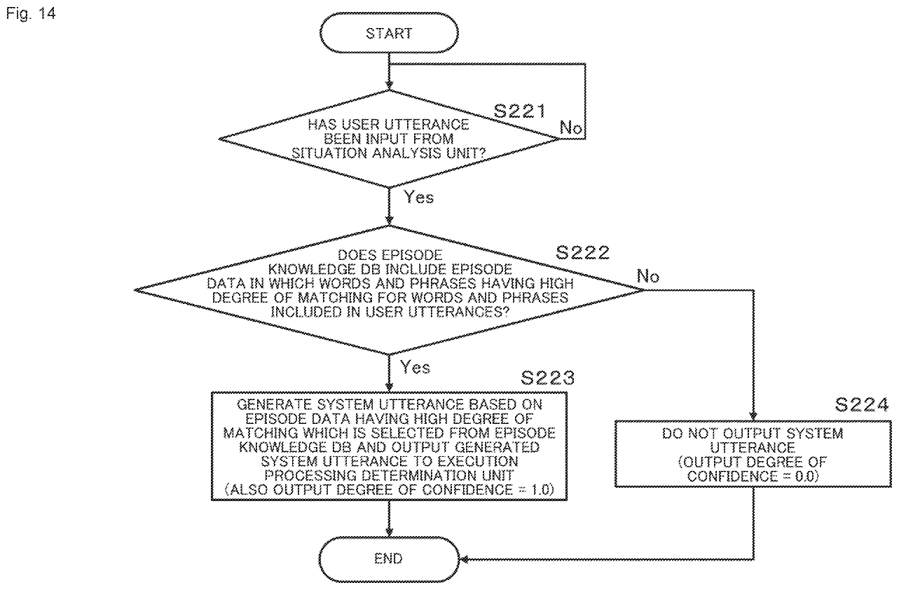

Next, a processing sequence executed by the episode knowledge-based dialogue execution module 202 will be described with reference to a flowchart illustrated in FIG. 14.

Processing of each step in the flow illustrated in FIG. 14 will be sequentially described.

(Step S221)

First, in step S221, it is determined whether a user utterance has been input from the situation analysis unit 162, and in a case where it is determined that a user utterance has been input, the processing proceeds to step S222.

(Step S222)

Next, in step S222, the episode knowledge-based dialogue execution module 202 determines whether episode data including words and phrases that are the same as or similar to the words and phrases included in the input user utterance is registered in the episode knowledge DB 212.

As described above with reference to FIG. 13, the episode knowledge DB (database) 212 is a database in which detailed information on various dialogue episodes is registered.

In step S222, the episode knowledge-based dialogue execution module 202 determines whether episode data including words and phrases that are the same as or similar to the words and phrases included in the input user utterance is registered in the episode knowledge DB 212.

In a case where it is determined that episode data including words and phrases that are the same as or similar to the words and phrases included in the input user utterance is registered in the episode knowledge DB 212, the processing proceeds to step S223.

In a case where it is determined that episode data including words and phrases that are the same as or similar to the words and phrases included in the input user utterance is not registered in the episode knowledge DB 212, the processing proceeds to step S224.

(Step S223)

In a case where it is determined in step S222 that episode data including words and phrases that are the same as or similar to the words and phrases included in the input user utterance is registered in the episode knowledge DB 212, the processing proceeds to step S223.

In step S223, the episode knowledge-based dialogue execution module 202 generates a system utterance based on episode detailed information included in the episode acquired from the episode knowledge DB 212 and outputs the generated system utterance to the execution processing determination unit 210 illustrated in FIG. 7.

Note that the value of the degree of confidence which is an index value indicating the degree of confidence of the acquired system utterance may also be output to the execution processing determination unit 210 together with the output of the system utterance.

In this case, the generation (acquisition) of a system utterance has been successful, and thus the value of the degree of confidence=1.0 is output.

(Step S224)

On the other hand, in a case where it is determined in a step S222 that episode data including words and phrases that are the same as or similar to the words and phrases included in the input user utterance is not registered in the episode knowledge DB 212, the processing proceeds to step S224.

In step S224, the episode knowledge-based dialogue execution module 202 does not execute the output of a system utterance to the execution processing determination unit 210.

Note that, in a case where the value of the degree of confidence which is an index value indicating the degree of confidence of the system utterance is output, the generation (acquisition) of a system utterance has not been successful, and thus the value of the degree of confidence=0.0 is output to the execution processing determination unit 210.

(4-3. System Utterance Generation Processing Performed by RDF Knowledge-Based Dialogue Execution Module)

Next, the system utterance generation processing using the resource description framework (RDF) knowledge-based dialogue execution module 203 which is executed in step S113 of the flow illustrated in FIG. 8 will be described.

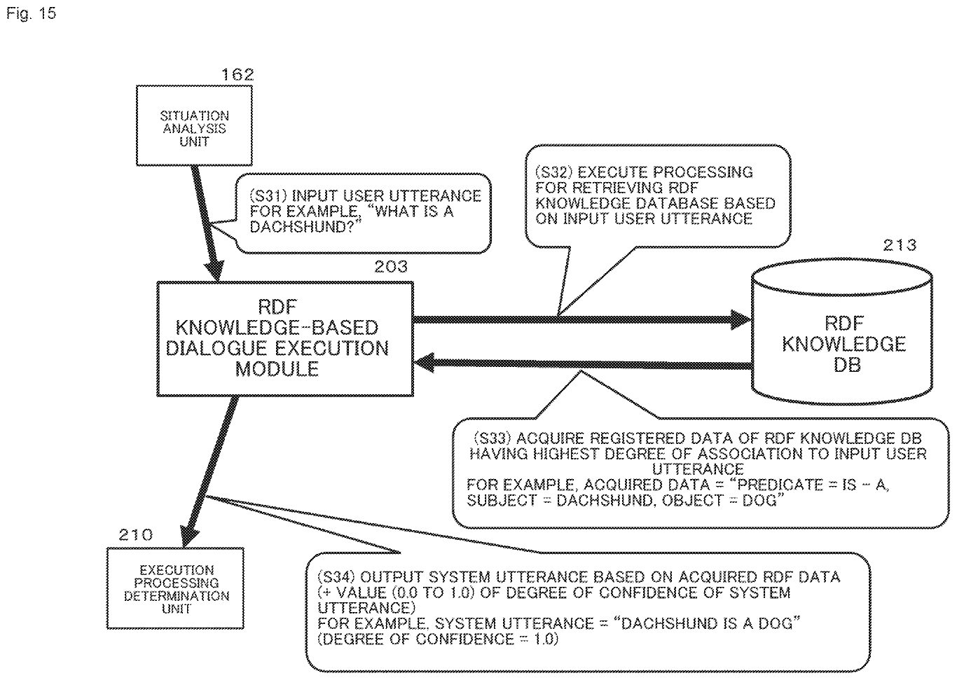

Details of the system utterance generation processing using the RDF knowledge-based dialogue execution module 203 will be described with reference to FIG. 15. FIG. 15 illustrates the RDF knowledge-based dialogue execution module 203. The RDF knowledge-based dialogue execution module 203 generates a system utterance with reference to RDF knowledge data stored in the RDF knowledge DB (database) 213 illustrated in FIG. 15.

The RDF knowledge DB (database) 213 is a database which is installed in the robot control unit 150 or in an external device such as an external server.

Note that the RDF knowledge-based dialogue execution module 203 and the RDF knowledge DB (database) 213 may be configured in the robot control unit 150 of the information processing device 100 illustrated in FIG. 4, but may be configured to be provided in an external server that can communicate with the information processing device 100.

The RDF knowledge-based dialogue execution module 203 executes processing in the order of steps S31 to S34 illustrated in FIG. 15. That is, the RDF knowledge-based system utterance generation algorithm is executed to generate an RDF knowledge-based system utterance.

Note that RDF is an abbreviation of a resource description framework, which is a framework for mainly describing information (resources) on the Web, and is a framework standardized in W3C.

RDF is a framework for describing relationships between elements, and describes relationship information related to information (resources) with three elements, that is, a subject, a predicate, and an object.

For example, information (resources) of “Dachshund is a dog.” is divided into the following three elements and is described as information in which a relationship between the three elements is determined.

Subject=Dachshund

Predicate=is (ia a)

Object=a dog

Data in which a relationship between the elements is recorded is recorded in the RDF knowledge database 213.

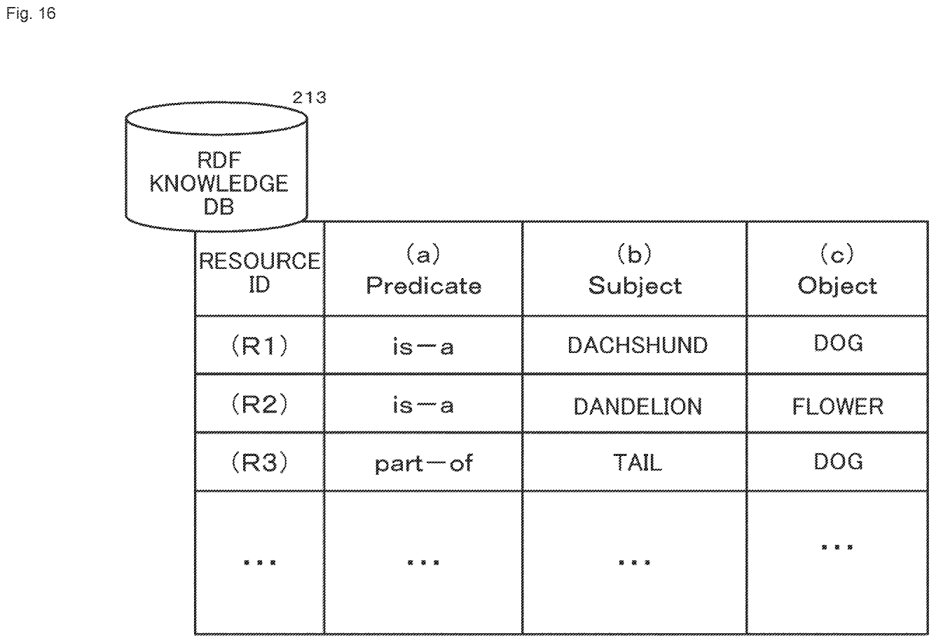

An example of stored data of the RDF knowledge database 213 is illustrated in FIG. 16.

As illustrated in FIG. 16, various information is divided into the following three elements and recorded in the RDF knowledge database 213.

(a) Predicate

(b) Subject

(c) Object

By referring to the registered information of the RDF knowledge DB (database) 213, elements included in various information and relationships between the elements can be known.

The RDF knowledge-based dialogue execution module 203 generates an optimum system utterance corresponding to a user utterance with reference to registered data of the RDF knowledge DB (database) 213 in which the elements included in various information and relationships between the elements are recorded.

The RDF knowledge-based dialogue execution module 203 executes processing in the order of steps S31 to S34 illustrated in FIG. 15. That is, the RDF knowledge-based system utterance generation algorithm is executed to generate an RDF knowledge-based system utterance.

First, in step S31, a user utterance is input from the situation analysis unit 162. For example, the following user utterance is input.

User utterance=“What is a dachshund?”

Next, in step S32, the RDF knowledge-based dialogue execution module 203 executes processing for retrieving registered data of the RDF knowledge DB based on the input user utterance.

As described above with reference to FIG. 16, the RDF knowledge DB (database) 213 is a database in which the following three divided elements are recorded for various information.

(a) Predicate

(b) Subject

(c) Object

By referring to the registered information of the RDF knowledge DB (database) 213, elements included in various information and relationships between the elements can be known.

In step S32, the RDF knowledge-based dialogue execution module 203 executes processing for retrieving registered data of the RDF knowledge DB based on the input user utterance.

Processing in a case where the following user utterance is input will be described.

User utterance=“What is a dachshund?”

In this case, in step S33, the RDF knowledge-based dialogue execution module 203 extracts information (resources) of a resource ID=(R1) from the registered data of the RDF knowledge DB illustrated in FIG. 16 as information (resources) including the most words and phrases that are the same as words and phrases included in a user's utterance.

Next, in step S34, the RDF knowledge-based dialogue execution module 203 generates a system utterance based on information included in the entry of the resource ID (R1) acquired from the RDF knowledge DB (database) 213, that is, the following elements and information between the elements, and outputs the generated system utterance to the execution processing determination unit 210 illustrated in FIG. 7.

Subject=Dachshund

Predicate=is (ia a)

Object=a dog

For example, the following system utterance is generated and output to the execution processing determination unit 210.

System utterance=“Dachshund is a dog.”

Note that a configuration may be adopted in which the RDF knowledge-based dialogue execution module 203 generates the value of the degree of confidence which is an index value indicating the degree of confidence of an output system utterance, for example, the degree of confidence=0.0 to 1.0 at the time of outputting the system utterance and outputs the generated value of the degree of confidence to the execution processing determination unit 210 together with the system utterance.

For example, the degree of confidence=1.0 is output in a case where the generation of a system utterance has been successful, and the degree of confidence=0.0 is output in a case where the generation of a system utterance has not been successful. Note that, as described above, a configuration can also be adopted in which the dialogue execution modules (dialogue engines) output only a system utterance and do not output the value of the degree of confidence.

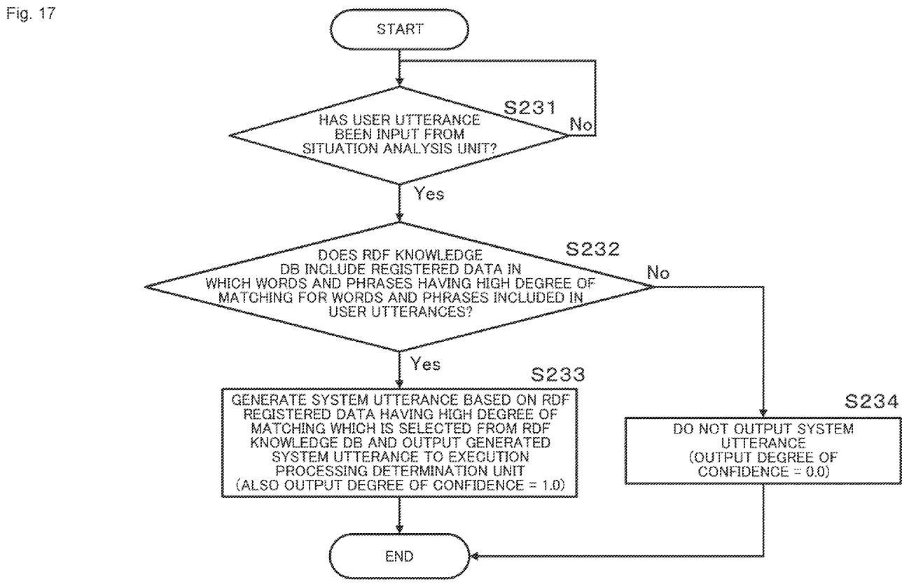

Next, a processing sequence executed by the RDF knowledge-based dialogue execution module 203 will be described with reference to a flowchart illustrated in FIG. 17.

Processing of each step in the flow illustrated in FIG. 17 will be sequentially described.

(Step S231)

First, in step S231, it is determined whether a user utterance has been input from the situation analysis unit 162, and in a case where it is determined that a user utterance has been input, the processing proceeds to step S232.

(Step S232)

Next, in step S232, the RDF knowledge-based dialogue execution module 203 determines whether resource data including words and phrases that are the same as or similar to the words and phrases included in the input user utterance is registered in the RDF knowledge DB 213.

As described above with reference to FIG. 16, the RDF knowledge DB (database) 213 is a database in which elements constituting various information (resources) and relationships between the elements are recorded.

In step S232, the RDF knowledge-based dialogue execution module 203 determines whether information (resources) including words and phrases that are the same as or similar to the words and phrases included in the input user utterance is registered in the RDF knowledge DB 213.

In a case where it is determined that information (resources) including words and phrases that are the same as or similar to the words and phrases included in the input user utterance is registered in the RDF knowledge DB 213, the processing proceeds to step S233.

In a case where it is determined that information (resources) including words and phrases that are the same as or similar to the words and phrases included in the input user utterance is not registered in the RDF knowledge DB 213, the processing proceeds to step S234.

(Step S233)

In a case where it is determined in step S232 that information (resources) including words and phrases that are the same as or similar to the words and phrases included in the input user utterance is registered in the RDF knowledge DB 213, the processing proceeds to step S233.

In step S233, the RDF knowledge-based dialogue execution module 203 acquires the information (resources) including words and phrases that are the same as or similar to the words and phrases included in the input user utterance from the RDF knowledge DB 213, generates a system utterance based on the acquired information, and outputs the generated system utterance to the execution processing determination unit 210 illustrated in FIG. 7.

Note that the value of the degree of confidence which is an index value indicating the degree of confidence of the acquired system utterance may also be output to the execution processing determination unit 210 together with the output of the system utterance.

In this case, the generation (acquisition) of a system utterance has been successful, and thus the value of the degree of confidence=1.0 is output.

(Step S234)

On the other hand, in a case where it is determined in step S232 that information (resources) including words and phrases that are the same as or similar to the words and phrases included in the input user utterance is not registered in the RDF knowledge DB 213, the processing proceeds to step S234.

In step S234, the RDF knowledge-based dialogue execution module 203 does not execute the output of a system utterance to the execution processing determination unit 210.

Note that, in a case where the value of the degree of confidence which is an index value indicating the degree of confidence of the system utterance is output, the generation (acquisition) of a system utterance has not been successful, and thus the value of the degree of confidence=0.0 is output to the execution processing determination unit 210.

(4-4. System Utterance Generation Processing Performed by Situation Verbalization & RDF Knowledge-Based Dialogue Execution Module)

Next, the system utterance generation processing using the situation verbalization & resource description framework (RDF) knowledge-based dialogue execution module 204 which is executed in step S114 of the flow illustrated in FIG. 8 will be described.

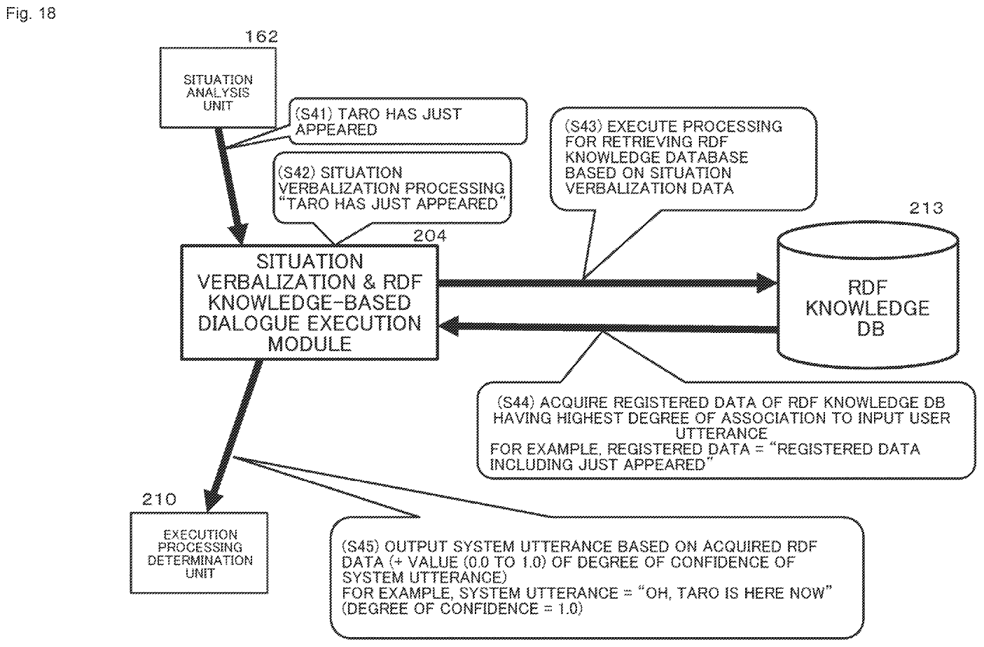

Details of the system utterance generation processing using the situation verbalization & RDF knowledge-based dialogue execution module 204 will be described with reference to FIG. 18.

FIG. 18 illustrates the situation verbalization & RDF knowledge-based dialogue execution module 204. The situation verbalization & RDF knowledge-based dialogue execution module 204 generates a system utterance with reference to the RDF knowledge data stored in the RDF knowledge DB (database) 213 illustrated in FIG. 18.

The RDF knowledge DB (database) 213 is a database which is installed in the robot control unit 150 or in an external device such as an external server.

The RDF knowledge DB (database) 213 illustrated in FIG. 18 is a database which is the same as the RDF knowledge DB (database) 213 described above with reference to FIGS. 15 and 16. That is, the database is a database in which relationships between three divided elements, that is, a subject, a predicate, and an object are recorded for various information (resources).

Note that the situation verbalization & RDF knowledge-based dialogue execution module 204 and the RDF knowledge DB (database) 213 may be configured in the robot control unit 150 of the information processing device 100 illustrated in FIG. 4, but may be configured to be provided in an external server that can communicate with the information processing device 100.

The situation verbalization & RDF knowledge-based dialogue execution module 204 executes processing in the order of steps S41 to S45 illustrated in FIG. 15. That is, the situation verbalization & RDF knowledge-based system utterance generation algorithm is executed to generate a situation verbalization & RDF knowledge-based system utterance.

First, in step S41, the situation verbalization & RDF knowledge-based dialogue execution module 204 inputs situation information from the situation analysis unit 162. Here, instead of inputting a user utterance, for example, situation information based on an image captured by a camera is input.

For example, the following situation information is input.

Situation information=“Taro has just appeared.”

Next, in step S42, the situation verbalization & RDF knowledge-based dialogue execution module 204 executes verbalization processing of the input situation information.

This is processing for describing an observed situation as text information which is the same as a user utterance. For example, the following situation verbalization information is generated.

Situation verbalization information=Taro has just appeared

Next, in step S43, the situation verbalization & RDF knowledge-based dialogue execution module 204 executes retrieval processing of registered data of the RDF knowledge DB 213 based on the generated situation verbalization information.

As described above with reference to FIG. 16, the RDF knowledge DB (database) 213 is a database in which relationships between the following three divided elements are recorded for various information.

(a) Predicate

(b) Subject

(c) Object

By referring to the registered information of the RDF knowledge DB (database) 213, elements included in various information and relationships between the elements can be known.

In step S43, the situation verbalization & RDF knowledge-based dialogue execution module 204 executes processing for retrieving registered data of the RDF knowledge DB based on the generated situation verbalization information.

Processing for the following situation verbalization information will be described.

Situation verbalization information=Taro has just appeared

In this case, in step S44, the situation verbalization & RDF knowledge-based dialogue execution module 204 extracts information (resources) including the most words and phrases that are the same as words and phrases included in the above-described situation verbalization information from the registered data of the RDF knowledge DB.

Next, in step S45, the situation verbalization & RDF knowledge-based dialogue execution module 204 generates a system utterance based on the information acquired from the RDF knowledge DB (database) 213 and outputs the generated system utterance to the execution processing determination unit 210 illustrated in FIG. 7.

For example, the following system utterance is generated and output to the execution processing determination unit 210.

System utterance=“Oh, Taro is here now.”

Note that a configuration may be adopted in which the situation verbalization & RDF knowledge-based dialogue execution module 204 generates the value of the degree of confidence which is an index value indicating the degree of confidence of an output system utterance, for example, the degree of confidence=0.0 to 1.0 at the time of outputting the system utterance and outputs the generated value of the degree of confidence to the execution processing determination unit 210 together with the system utterance.

For example, the degree of confidence=1.0 is output in a case where the generation of a system utterance has been successful, and the degree of confidence=0.0 is output in a case where the generation of a system utterance has not been successful. Note that, as described above, a configuration can also be adopted in which the dialogue execution modules (dialogue engines) output only a system utterance and do not output the value of the degree of confidence.

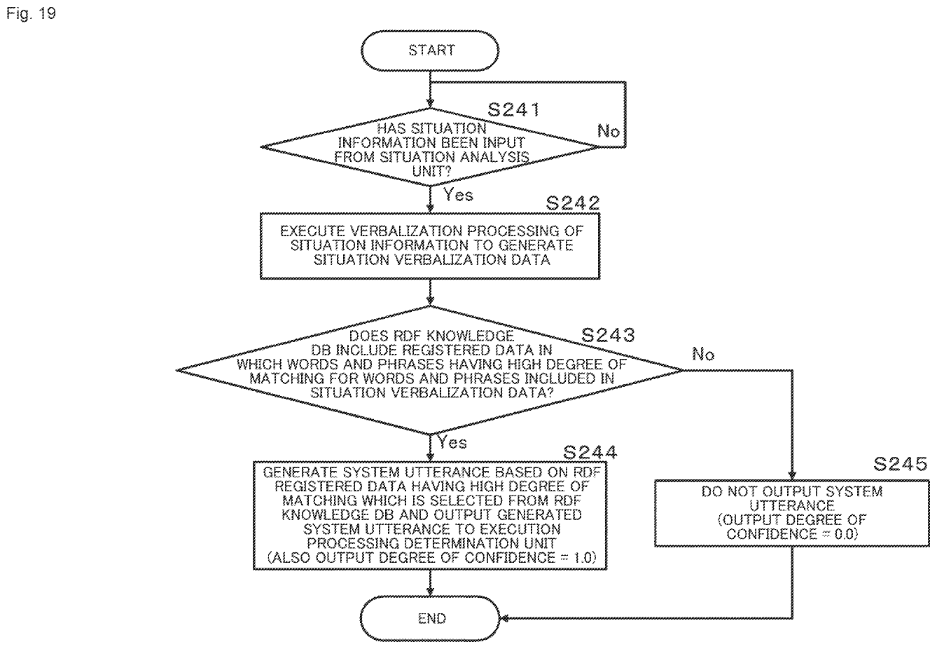

Next, a processing sequence executed by the situation verbalization & RDF knowledge-based dialogue execution module 204 will be described with reference to a flowchart illustrated in FIG. 19.

Processing of each step in the flow illustrated in FIG. 19 will be sequentially described.

(Step S241)

First, in step S241, it is determined whether situation information has been input from the situation analysis unit 162, and in a case where it is determined that situation information has been input, the processing proceeds to step S242.

(Step S242)

Next, in step S242, the situation verbalization & RDF knowledge-based dialogue execution module 204 executes verbalization processing of the input situation information.

(Step S243)

Next, in step S243, the situation verbalization & RDF knowledge-based dialogue execution module 204 determines whether resource data including words and phrases that are the same as or similar to the words and phrases included in the situation verbalization data generated in step S242 is registered in the RDF knowledge DB 213.

As described above with reference to FIG. 16, the RDF knowledge DB (database) 213 is a database in which elements constituting various information (resources) and relationships between the elements are recorded.

In step S243, the situation verbalization & RDF knowledge-based dialogue execution module 204 determines whether information (resources) including words and phrases that are the same as or similar to the words and phrases included in the generated situation verbalization data is registered in the RDF knowledge DB 213.

In a case where it is determined that information (resources) including words and phrases that are the same as or similar to the words and phrases included in the generated situation verbalization data is registered in the RDF knowledge DB 213, the processing proceeds to step S244.

In a case where it is determined that that information (resources) including words and phrases that are the same as or similar to the words and phrases included in the generated situation verbalization data is not registered in the RDF knowledge DB 213, the processing proceeds to step S245.

(Step S244)

In a case where it is determined in step S243 that information (resources) including words and phrases that are the same as or similar to the words and phrases included in the generated situation verbalization data is registered in the RDF knowledge DB 213, the processing proceeds to step S244.

In step S244, the situation verbalization & RDF knowledge-based dialogue execution module 204 acquires the information (resources) including words and phrases that are the same as or similar to the words and phrases included in the generated situation verbalization data from the RDF knowledge DB 213, generates a system utterance based on the acquired information, and outputs the generated system utterance to the execution processing determination unit 210 illustrated in FIG. 7.

Note that the value of the degree of confidence which is an index value indicating the degree of confidence of the acquired system utterance may also be output to the execution processing determination unit 210 together with the output of the system utterance.

In this case, the generation (acquisition) of a system utterance has been successful, and thus the value of the degree of confidence=1.0 is output.

(Step S245)

On the other hand, in a case where it is determined in step S243 that information (resources) including words and phrases that are the same as or similar to the words and phrases included in the generated situation verbalization data is not registered in the RDF knowledge DB 213, the processing proceeds to step S245.

In step S245, the situation verbalization & RDF knowledge-based dialogue execution module 204 does not execute the output of a system utterance to the execution processing determination unit 210.

Note that, in a case where the value of the degree of confidence which is an index value indicating the degree of confidence of the system utterance is output, the generation (acquisition) of a system utterance has not been successful, and thus the value of the degree of confidence=0.0 is output to the execution processing determination unit 210.

(4-5. System Utterance Generation Processing Performed by Machine Learning Model-Based Dialogue Execution Module)

Next, the system utterance generation processing using the machine learning model-based dialogue execution module 205 which is executed in step S115 of the flow illustrated in FIG. 8 will be described.

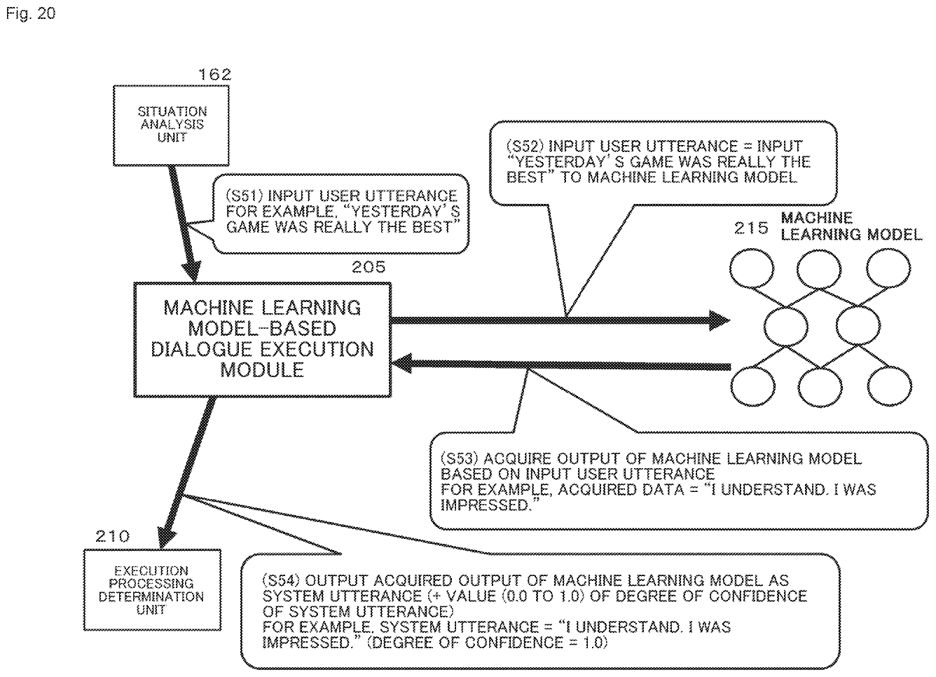

Details of the system utterance generation processing using the machine learning model-based dialogue execution module 205 will be described with reference to FIG. 20.

FIG. 20 illustrates the machine learning model-based dialogue execution module 205. The machine learning model-based dialogue execution module 205 inputs a user utterance to the machine learning model 215 illustrated in FIG. 20 and acquires a system utterance as an output from the machine learning model 215.

The machine learning model 215 is installed in the robot control unit 150 or in an external device such as an external server.

The machine learning model 215 illustrated in FIG. 20 is a learning model that receives an input of a user utterance and outputs a system utterance as an output. The machine learning model is a learning model which is generated through machine learning processing of data constituted by set data including a large number of various different input sentences and response sentences, that is, sets of user utterances and output utterances (system utterances).

The learning model is, for example, a learning model in units of users, and is sequentially updated.

Note that the machine learning model-based dialogue execution module 205 and the machine learning model 215 may be configured in the robot control unit 150 of the information processing device 100 illustrated in FIG. 4, but may be configured to be provided in an external server that can communicate with the information processing device 100.

The machine learning model-based dialogue execution module 205 executes processing in the order of steps S51 to S52 illustrated in FIG. 20. That is, a machine learning model-based system utterance is generated by executing a machine learning model-based system utterance generation algorithm using a machine learning model.

First, in step S51, the machine learning model-based dialogue execution module 205 inputs a user utterance from the situation analysis unit 162.

For example, the following user utterance is input.

User utterance=“Yesterday's game was really the best.”

Next, in step S52, the machine learning model-based dialogue execution module 204 inputs input user utterance “Yesterday's game was really the best” to the machine learning model 215.

The machine learning model 215 is a learning model that outputs a system utterance as an output in a case where a user utterance is input thereto.

In step S52, when the user utterance “Yesterday's game was really the best” is input to the machine learning model 215, the machine learning model 215 outputs a system utterance as an output for the input.

In step S53, the machine learning model-based dialogue execution module 205 acquires the output from the machine learning model 215. The acquired data is, for example, the following data.

Acquired data=“I understand. I was impressed.”

Next, in step S54, the machine learning model-based dialogue execution module 205 outputs the data acquired from the machine learning model 215 to the execution processing determination unit 210 illustrated in FIG. 7 as a system utterance. For example, the following system utterance is output to the execution processing determination unit 210.

System utterance=“I understand. I was impressed.”

Note that a configuration may be adopted in which the machine learning model-based dialogue execution module 205 generates the value of the degree of confidence which is an index value indicating the degree of confidence of an output system utterance, for example, the degree of confidence=0.0 to 1.0 at the time of outputting the system utterance and outputs the generated value of the degree of confidence to the execution processing determination unit 210 together with the system utterance.

For example, the degree of confidence=1.0 is output in a case where the generation of a system utterance has been successful, and the degree of confidence=0.0 is output in a case where the generation of a system utterance has not been successful. Note that, as described above, a configuration can also be adopted in which the dialogue execution modules (dialogue engines) output only a system utterance and do not output the value of the degree of confidence.

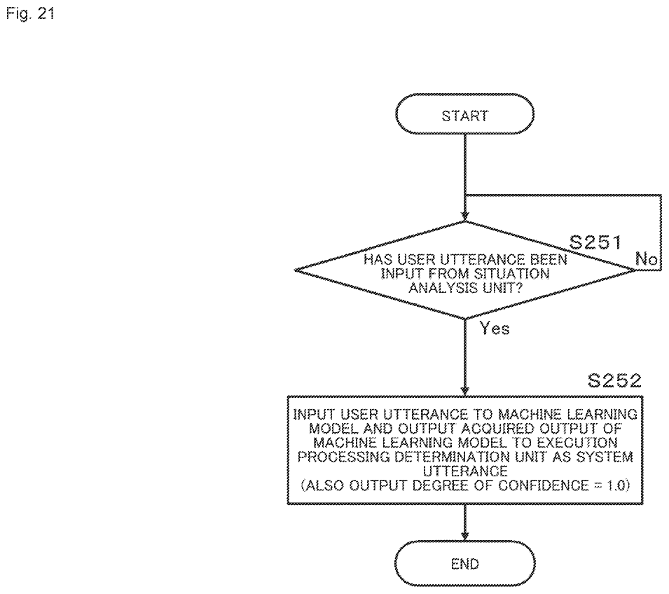

Next, a processing sequence executed by the machine learning model-based dialogue execution module 205 will be described with reference to a flowchart illustrated in FIG. 21.

Processing of each step in the flow illustrated in FIG. 21 will be sequentially described.

(Step S251)

First, in step S251, it is determined whether a user utterance has been input from the situation analysis unit 162, and in a case where it is determined that a user utterance has been input, the processing proceeds to step S252.

(Step S252)

Next, in step S252, the machine learning model-based dialogue execution module 205 inputs the user utterance input in step S251 to a machine learning model, acquires an output of the machine learning model, and outputs the output to the execution processing determination unit as a system utterance.

Note that the value of the degree of confidence which is an index value indicating the degree of confidence of the acquired system utterance may also be output to the execution processing determination unit 210 together with the system utterance. In this case, the generation (acquisition) of a system utterance has been successful, and thus the value of the degree of confidence=1.0 is output.

In this manner, in steps S111 to S115 of the flow illustrated in FIG. 8, the following five processes are executed in parallel.

(S111) Generation of a system utterance using the scenario-based dialogue execution module (+the degree of confidence of an utterance) (processing referring to a scenario DB is executed)

(S112) Generation of a system utterance using the episode knowledge-based dialogue execution module (+the degree of confidence of an utterance) (processing referring to an episode knowledge DB is executed)

(S113) Generation of a system utterance using the RDF knowledge-based dialogue execution module (+the degree of confidence of an utterance) (processing referring to an RDF knowledge DB is executed)

(S114) Generation of a system utterance using the RDF knowledge-based dialogue execution module accompanying situation verbalization processing (+the degree of confidence of an utterance) (processing referring to the RDF knowledge DB is executed)

(S115) Generation of a system utterance using the machine learning model-based dialogue execution module (+the degree of confidence of an utterance) (processing referring to a machine learning model is executed)

As described above, these five processes may be executed in the data processing unit 160 of the robot control unit 150 illustrated in FIG. 4, or may be executed as distributed processing by using an external device such as an external server connected through the communication unit 170.

For example, a configuration may be adopted in which five external servers execute five processes of steps S111 to S115, and the processing determination unit (decision making unit) 163 in the data processing unit 160 of the robot control unit 150 illustrated in FIG. 4 receives processing results.

Processing results of steps S111 to S115 of the flow illustrated in FIG. 8, that is, system utterances generated by the five dialogue execution modules (dialogue engines) 201 to 205 illustrated in FIG. 7 are input to the execution processing determination unit 210 illustrated in FIG. 7.

[5. Details of Processing Executed by Execution Processing Determination Unit]

Next, details of processing executed by the execution processing determination unit 210 will be described.

As described above with reference to FIG. 7, the execution processing determination unit 210 inputs the system utterances generated by the five dialogue execution modules (dialogue engines) 201 to 205 and selects one system utterance to be output, from among the input system utterances.

The selected system utterance is output to the dialogue processing unit 164, is converted into text, and is output through the speech output unit (speaker) 131.

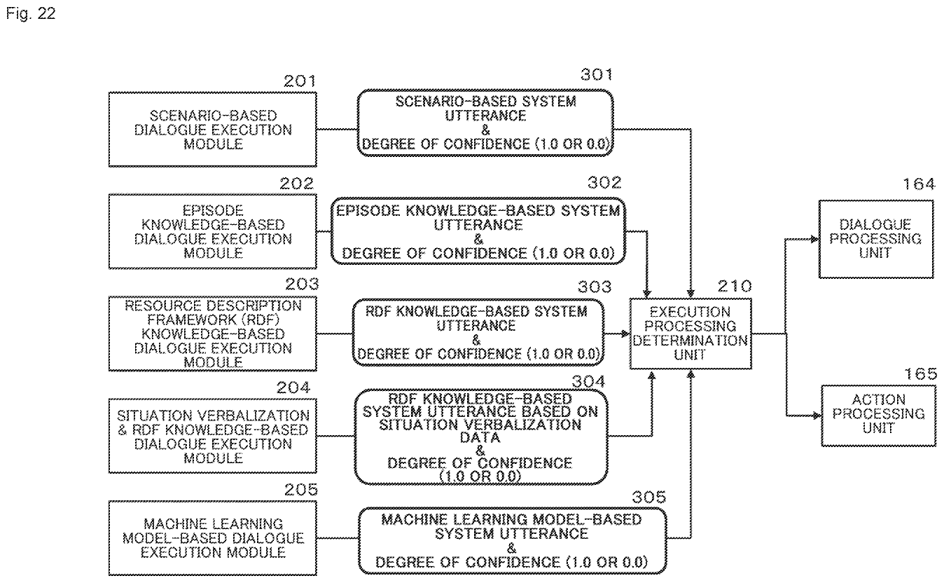

Processing executed by the execution processing determination unit 210 will be described with reference to FIG. 22.

As illustrated in FIG. 22, the execution processing determination unit 210 inputs processing results in the respect modules from the following five dialogue execution modules.

(1) The scenario-based dialogue execution module 201

(2) The episode knowledge-based dialogue execution module 202

(3) The resource description framework (RDF) knowledge-based dialogue execution module 203

(4) The situation verbalization & RDF knowledge-based dialogue execution module 204

(5) The machine learning model-based dialogue execution module 205

These five dialogue execution modules (dialogue engines) 201 to 205 execute parallel processing to generate system responses by different algorithms.

The system utterances generated by these five modules are input to the execution processing determination unit 210.

The five dialogue execution modules (dialogue engines) 201 to 205 input the system utterances generated by the modules and the degrees of confidence (0.0 to 1.0) to the execution processing determination unit 210.

The execution processing determination unit 210 selects one system utterance having the largest value of the degree of confidence from among the plurality of system utterances that are input from the five dialogue execution modules (dialogue engines) 201 to 205, and determines a system utterance to be output from the output unit 130 of the data input and output unit 110. That is, a system utterance to be output by the dialogue robot 10 is determined.

Note that, in a case where the values of the degrees of confidence which are set to correspond to the system utterances input from the plurality of dialogue execution modules (dialogue engines) 201 to 205 are the same, the execution processing determination unit 210 determines a system utterance to be output by the dialogue robot in accordance with preset priorities in units of dialogue execution modules (dialogue engines).

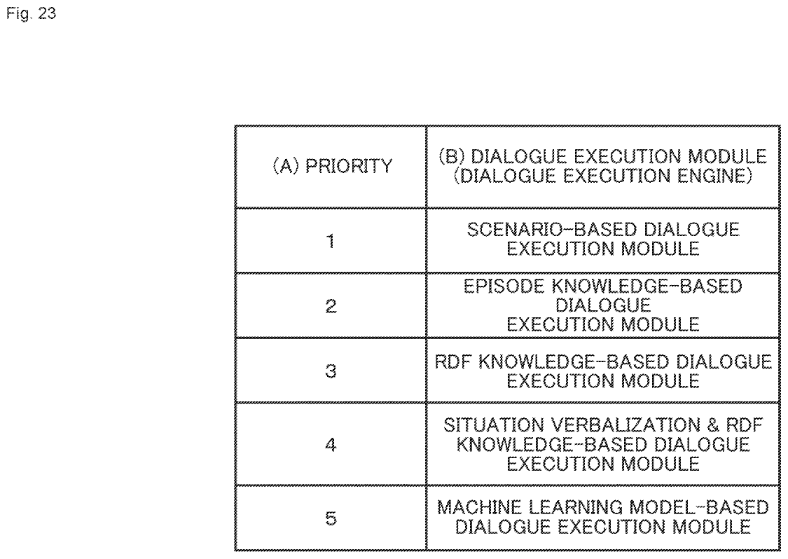

An example of preset priorities in units of dialogue execution modules (dialogue engines) will be described with reference to FIG. 23.

FIG. 23 is a diagram illustrating an example of preset priorities in units of dialogue execution modules (dialogue engines).

Regarding the priorities, 1 is the highest priority, and 5 is the lowest priority.

In the example illustrated in FIG. 23, dialogue execution module-compatible priorities are set as follows.

Priority 1=the scenario-based dialogue execution module 201

Priority 2=the episode knowledge-based dialogue execution module 202

Priority 3=the resource description framework (RDF) knowledge-based dialogue execution module 203

Priority 4=the situation verbalization & RDF knowledge-based dialogue execution module 204

Priority 5=the machine learning model-based dialogue execution module 205

First, the execution processing determination unit 210 selects processing for selecting a system utterance having the value of the highest degree of confidence as a system utterance to be output, based on the values of the degrees of confidence which are input from the plurality of dialogue execution modules (dialogue engines). However, in a case where there are a plurality of system utterances having the highest degree of confidence, a system utterance to be output by the dialogue robot is determined in accordance with the preset priorities in units of dialogue execution modules (dialogue engines) illustrated in FIG. 23.

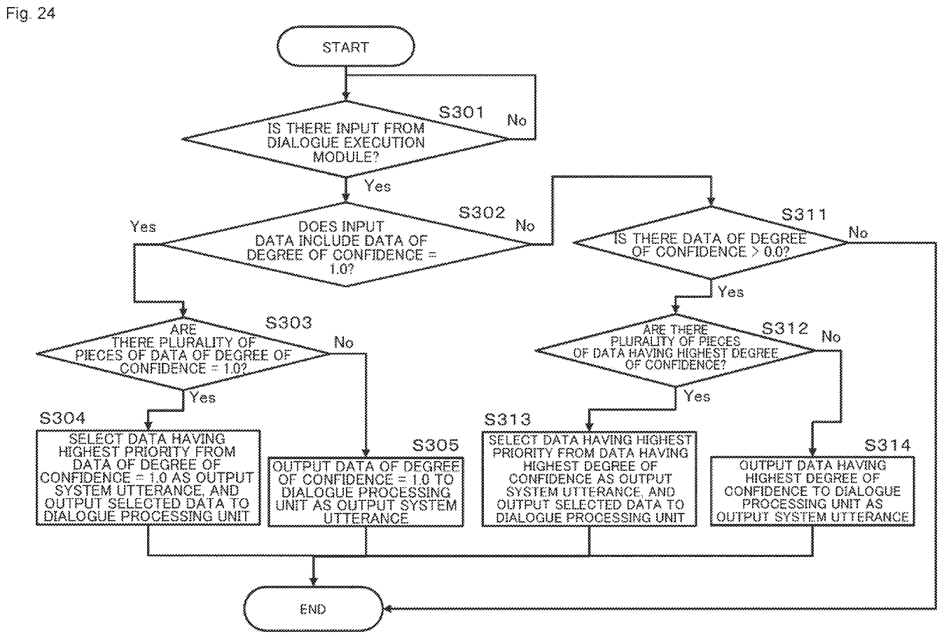

Next, a sequence of processing executed by the execution processing determination unit 210 will be described with reference to a flowchart illustrated in FIG. 24. Processes of steps will be sequentially described.

(Step S301)

First, in step S301, the execution processing determination unit 210 determines whether there is an input from the following five dialogue execution modules (dialogue engines) 201 to 205.

The scenario-based dialogue execution module 201

The episode knowledge-based dialogue execution module 202

The resource description framework (RDF) knowledge-based dialogue execution module 203

The situation verbalization & RDF knowledge-based dialogue execution module 204

The machine learning model-based dialogue execution module 205

That is, it is determined whether data of system utterances generated in accordance with algorithms executed in the respective modules and the degrees of confidence (0.0 to 1.0) has been input.

In a case where the data has been input, the processing proceeds to step S302.

(Step S302)

Next, in step S302, the execution processing determination unit 210 determines whether data of the degree of confidence=1.0 is included in the data input from the five dialogue execution modules (dialogue engines) 201 to 205.

In a case where the data is included in the input data, the processing proceeds to step S303.

In a case where the data is not included in the input data, the processing proceeds to step S311.

(Step S303)

In step S302, in a case where it is determined that data of the degree of confidence=1.0 is included in the data input from the five dialogue execution modules (dialogue engines) 201 to 205, the execution processing determination unit 210 subsequently determines in step S303 whether a plurality of pieces of data of the degree of confidence=1.0 are included in the data input from the five dialogue execution modules (dialogue engines) 201 to 205.

In a case where a plurality of pieces of data are included in the input data, the processing proceeds to step S304.

In a case where only one piece of data is included in the input data, not a plurality of pieces of data, the processing proceeds to step S305.

(Step S304)

In step S303, in a case where a plurality of pieces of data of the degree of confidence=1.0 are included in the data input from the five dialogue execution modules (dialogue engines) 201 to 205, the processing of step S304 is executed.

In step S304, the execution processing determination unit 210 selects a system utterance output by a high-priority module as a system utterance to be finally output by the dialogue robot from among the plurality of system utterances of the degree of confidence=1.0, in accordance with the preset priorities in units of modules.

The execution processing determination unit 210 outputs the selected system utterance to the dialogue processing unit 164.

(Step S305)

On the other hand, in step S303, in a case where only one piece of data of the degree of confidence=1.0 is included in the data input from the five dialogue execution modules (dialogue engines) 201 to 205, the processing of step S305 is executed.

In step S305, the execution processing determination unit 210 selects one system utterance of the degree of confidence=1.0 as a system utterance to be finally output by the dialogue robot.

The execution processing determination unit 210 outputs the selected system utterance to the dialogue processing unit 164.

(Step S311)

In the determination processing of step S302, in a case where it is determined that data of the degree of confidence=1.0 is not included in the data input from the five dialogue execution modules (dialogue engines) 201 to 205, the execution processing determination unit 210 subsequently determines in step S311 whether data of the degree of confidence>0.0 is included in the data input from the five dialogue execution modules (dialogue engines) 201 to 205.

In a case where the data is included in the input data, the processing proceeds to step S312.

In a case where the data is not included in the input data, the processing is terminated. In this case, a system utterance is not output.

(Step S312)

In a case where it is determined in step S311 that data of the degree of confidence>0.0 is included in the data input from the five dialogue execution modules (dialogue engines) 201 to 205, the execution processing determination unit 210 subsequently determines in step S312 whether a plurality of pieces of data having the highest degree of confidence of the degree of confidence>0.0 are included in the data input from the five dialogue execution modules (dialogue engines) 201 to 205.

In a case where a plurality of pieces of data are included in the input data, the processing proceeds to step S313.

In a case where only one piece of data is included in the input data, not a plurality of pieces of data, the processing proceeds to step S314.

(Step S313)

In step S312, in a case where a plurality of pieces of data having the highest degree of confidence of the degree of confidence>0.0 are included in the data input from the five dialogue execution modules (dialogue engines) 201 to 205, the processing of step S313 is executed.

In step S313, the execution processing determination unit 210 selects a system utterance output by the module having the highest priority as a system utterance to be finally output by the dialogue robot from among the plurality of system utterances having the highest degree of confidence in the data of the degree of confidence>0.0, in accordance with the preset priorities in units of modules. The execution processing determination unit 210 outputs the selected system utterance to the dialogue processing unit 164.

(Step S314)

On the other hand, in step S312, in a case where only one data of the highest degree of confidence of the degree of confidence>0.0 is included in the data input from the five dialogue execution modules (dialogue engines) 201 to 205, the processing of step S314 is executed.

In step S314, the execution processing determination unit 210 selects a system utterance having the highest degree of confidence of the degree of confidence>1.0 as a system utterance to be finally output by the dialogue robot.

The execution processing determination unit 210 outputs the selected system utterance to the dialogue processing unit 164.

In this manner, the execution processing determination unit 210 selects one system utterance having the largest value of the degree of confidence from among the plurality of system utterances that are input from the five dialogue execution modules (dialogue engines) 201 to 205, and sets the selected system utterance as a system utterance to be output by the dialogue robot.

In a case where the values of the degrees of confidence that are input from the plurality of dialogue execution modules (dialogue engines) are the same, a system utterance to be output by the dialogue robot is determined in accordance with preset priorities in units of dialogue execution modules (dialogue engines).

In this manner, the information processing device of the present disclosure operates a plurality of dialogue execution modules generating system utterances in accordance with different algorithms in parallel to generate a plurality of system utterances, selects an optimum system utterance from among the plurality of system utterances, and outputs the selected optimum system utterance.

By performing such processing, it is possible to output an optimum system utterance corresponding to various situations and to perform a dialogue with a user more naturally and smoothly.

[6. Example of System Utterance Output Performed by Information Processing Device of the Present Disclosure]

Next, a specific example of a system utterance performed through the above-described processing of the information processing device of the present disclosure will be described.

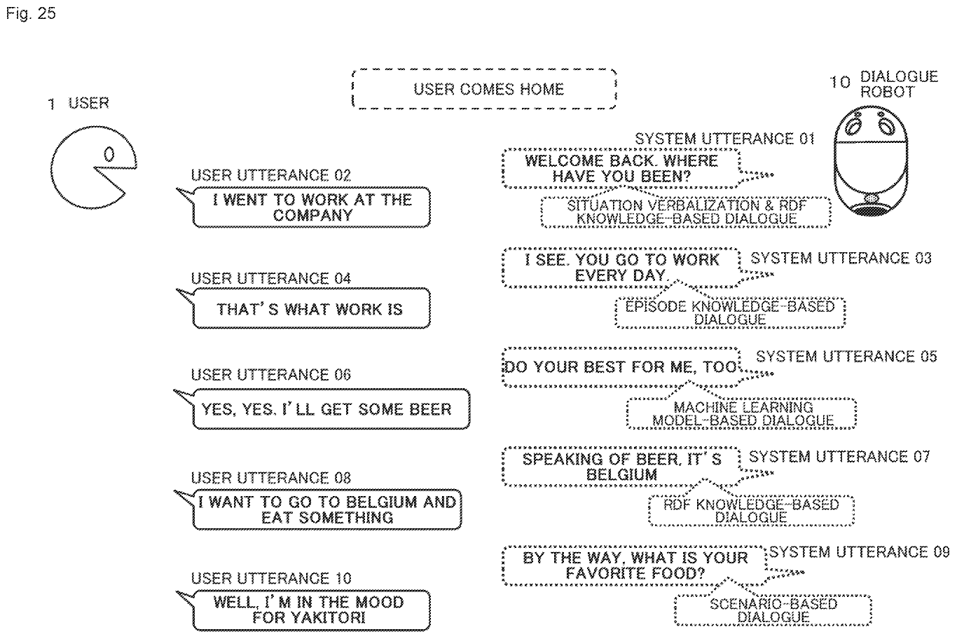

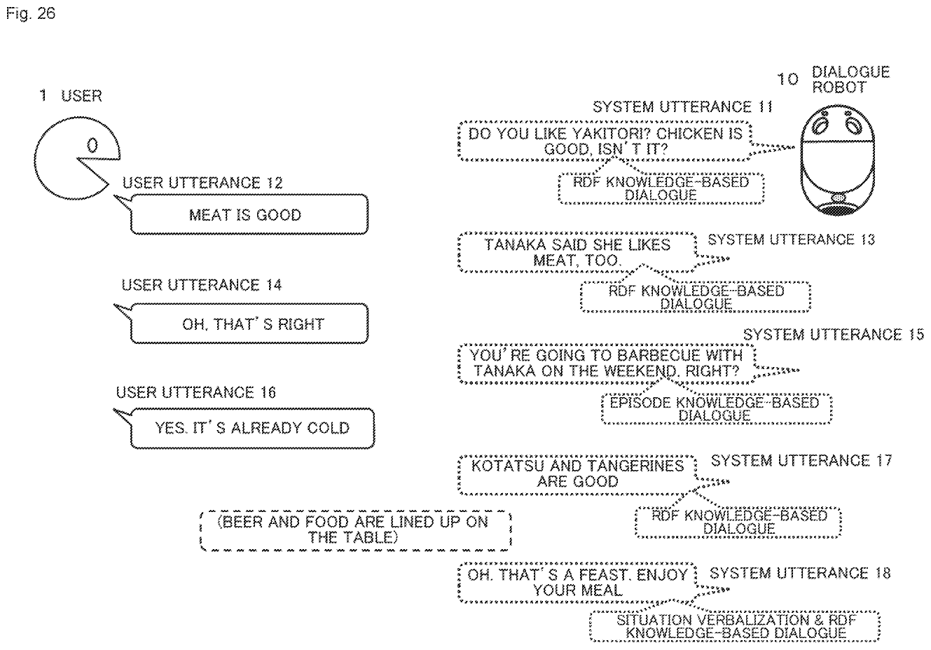

FIGS. 25 and 26 illustrate an example of a dialogue sequence between a user 1 and the dialogue robot 10.

The dialogue robot 10 performs system utterance generation processing according to the above-described processing of the present disclosure to execute a system utterance.

That is, a plurality of system utterances are generated by operating a plurality of dialogue execution modules generating system utterances in accordance with different algorithms in parallel, and an optimum system utterance is selected from among the system utterances and is output.

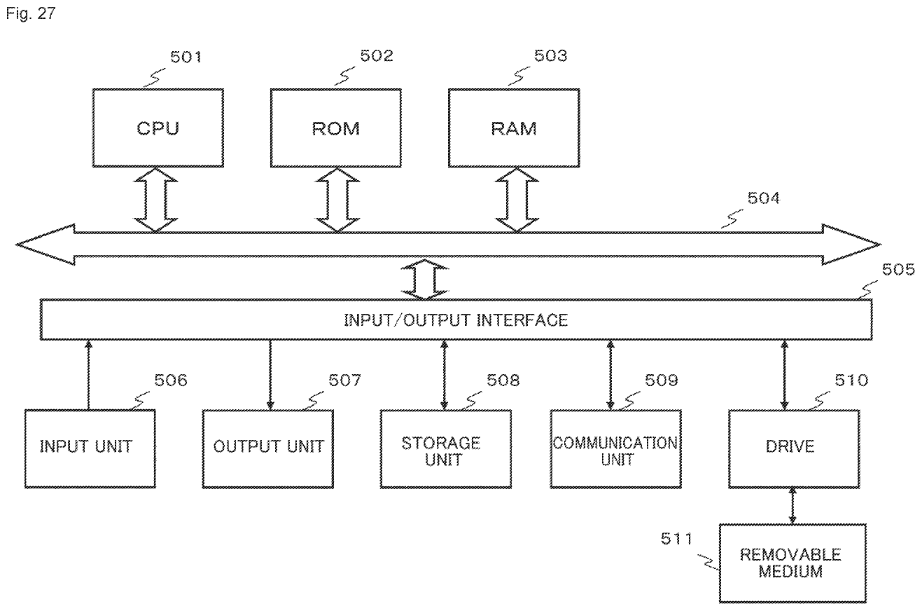

In FIGS. 26 and 27, the user 1 and the dialogue robot 10 alternately give utterances such as a system utterance 01, a user utterance 02, a system utterance 03, . . . , and a user utterance 18.

That is, the following utterance sequence is performed.

(User Comes Home)

System utterance=“Welcome back. Where have you been?”

User utterance=“I went to work at the company.”

System utterance=“I see. You go to work every day.”

User utterance=“That's what work is.”

System utterance=“Do your best for me, too.”

User utterance=“Yes, yes. I'll get some beer.”

System utterance=“Speaking of beer, it's Belgium.”

User utterance=“I want to go to Belgium and eat something.”

System utterance=“By the way, what is your favorite food?”

User utterance=“Well, I'm in the mood for yakitori.”

System utterance=“Do you like yakitori? Chicken is good, isn't it?”

User utterance=“Meat is good.”

System utterance=“Tanaka said she likes meat, too.”

User utterance=“Oh, that's right.”

System utterance=“You're going to barbecue with Tanaka on the weekend, right?”

User utterance=“Yes. It's already cold.”

System utterance=“Kotatsu and tangerines are good.”

(Beer and food are lined up on the table)

System utterance=“Oh. That's a feast. Enjoy your meat”

In these utterance sequences, each of the system utterances output by the dialogue robot 10 is one system utterance selected each time from among system utterances generated by the following five dialogue execution modules.

(1) The scenario-based dialogue execution module 201

(2) The episode knowledge-based dialogue execution module 202

(3) The resource description framework (RDF) knowledge-based dialogue execution module 203

(4) The situation verbalization & RDF knowledge-based dialogue execution module 204

(5) The machine learning model-based dialogue execution module 205

For example, the first system utterance=“Welcome back. Where have you been?” is a system utterance generated by the situation verbalization & RDF knowledge-based dialogue execution module 204 based on the user's situation, that is, (User comes home) situation information indicating that the user has come home.

The next system utterance=“I see. You go to work every day.” is a system utterance generate by the episode knowledge-based dialogue execution module 202 based on the previous user utterance, that is, the user utterance=“I went to work at the company”.

The next system utterance=“Do your best for me, too.” is a system utterance generated by the machine learning model-based dialogue execution module 205 based on the previous user utterance, that is, the user utterance=“That's what work is”.

The next system utterance=“Speaking of beer, it's Belgium.” is a system utterance generated by the resource description framework (RDF) knowledge-based dialogue execution module 203 based on the previous user utterance, that is, the user utterance=“Yes, yes. I'll get some beer”.

The next system utterance=“By the way, what is your favorite food?” is a system utterance generated by the scenario-based dialogue execution module 201 based on the previous user utterance, that is, the user utterance=“I want to go to Belgium and eat something”.

The same applies to the subsequent system utterances, and a plurality of dialogue execution modules generating system utterances in accordance with different algorithms are operated in parallel to generate a plurality of system utterances, and an optimum system utterance is selected from among the plurality of system utterances and is output.

In this manner, the information processing device of the present disclosure operates a plurality of dialogue execution modules generating system utterances in accordance with different algorithms in parallel to generate a plurality of system utterances, selects an optimum system utterance from among the plurality of system utterances, and outputs the selected optimum system utterance.

By performing such processing, it is possible to output an optimum system utterance corresponding to various situations and to perform a dialogue with a user more naturally and smoothly.

[7. Hardware Configuration Example of Information Processing Device]

Next, an example of a hardware configuration of an information processing device will be described with reference to FIG. 27.

Hardware described with reference to FIG. 27 is an example of a hardware configuration which is common to the information processing device described with reference to FIG. 4 and an external device such as an external server including a dialogue execution module (dialogue engine).

A central processing unit (CPU) 501 functions as a control unit or a data processing unit that executes various processes according to a program stored in a read only memory (ROM) 502 or a storage unit 508. For example, the process according to the sequence described in the above-described embodiment is executed. A random access memory (RAM) 503 stores programs and data executed by the CPU 501. The CPU 501, the ROM 502, and the RAM 503 are connected to each other by a bus 504.

The CPU 501 is connected to an input/output interface 505 via the bus 504, and the input/output interface 505 is connected to an input unit 506 including various switches, a keyboard, a mouse, a microphone, a sensor, and the like, and an output unit 507 including a display, a speaker, and the like. The CPU 501 executes various processes in response to a command input from the input unit 506, and outputs the processing results to, for example, the output unit 507.

The storage unit 508 connected to the input/output interface 505 is formed of, for example, a hard disk or the like, and stores a program executed by the CPU 501 and various pieces of data. A communication unit 509 functions as a transmission and reception unit for Wi-Fi communication, Bluetooth (registered trademark) (BT) communication, and other data communication via a network such as the Internet or a local area network, and communicates with an external device.

A drive 510 connected to the input/output interface 505 drives a removable medium 511 such as a magnetic disk, an optical disc, a magneto-optical disc, or a semiconductor memory such as a memory card, and records or reads data.

[8. Summary of Configuration of Present Disclosure]

Embodiments of the present disclosure have been described above in detail with reference to a specific embodiment. However, it will be apparent to those skilled in the art that modification and substation of the embodiments can be made without departing from the gist of the technology disclosed in the present disclosure. That is, the present invention has been disclosed according to an illustrative form, but the present disclosure should not be restrictively construed. The gist of the present disclosure should be determined in consideration of the claims.

The technology disclosed in the present specification can have the following configuration.

(1) An information processing device including:

a data processing unit configured to generate and output a system utterance, wherein
the data processing unit selects one system utterance from among a plurality of system utterances individually generated by a plurality of dialogue execution modules and outputs the selected system utterance.

(2) The information processing device according to (1), wherein

each of the plurality of dialogue execution modules generates a system utterance specific to an algorithm in accordance with different system utterance generation algorithms.

(3) The information processing device according to (1) or (2), wherein the data processing unit

inputs a user utterance, inputs a speech recognition result of the input user utterance to the plurality of dialogue execution modules, and
selects one system utterance from among system utterances generated based on the user utterance by the plurality of dialogue execution modules.

(4) The information processing device according to any one of (1) to (3), wherein the data processing unit

inputs situation information which is observation information, inputs the input situation information to the plurality of dialogue execution modules, and
selects one system utterance from among system utterances generated based on the situation information by the plurality of dialogue execution modules.

(5) The information processing device according to any one of (1) to (4), wherein the data processing unit selects a system utterance having a high value of the degree of confidence as an output system utterance, with reference to a system utterance-compatible degree of confidence which is set to correspond to the system utterance generated by each of the plurality of dialogue execution modules.

(6) The information processing device according to (5), wherein

in a case where there are a plurality of system utterances having a maximum value of the degree of confidence, the data processing unit selects a system utterance generated by a dialogue execution module having a high priority as an output system utterance in accordance with a predefined dialogue execution module-compatible priority.

(7) The information processing device according to any one of (1) to (6), wherein each of the plurality of dialogue execution modules generates a generated system utterance and the degree of confidence corresponding to the generated system utterance, and

the data processing unit selects a system utterance having a high value of the degree of confidence as an output system utterance.

(8) The information processing device according to any one of (1) to (7), wherein the plurality of dialogue execution modules include a scenario-based dialogue execution module that generates a system utterance with reference to a scenario database in which utterance set data including user utterances corresponding to various dialogue scenarios and system utterances is registered.

(9) The information processing device according to any one of (1) to (8), wherein the plurality of dialogue execution modules include an episode knowledge-based dialogue execution module that generates a system utterance with reference to an episode knowledge database in which various episode information is recorded.

(10) The information processing device according to any one of (1) to (9), wherein the plurality of dialogue execution modules include a resource description framework (RDF) knowledge-based dialogue execution module that generates a system utterance with reference to an RDF knowledge database in which elements included in various information and relationships between the elements are recorded.

(11) The information processing device according to any one of (1) to (10), wherein the plurality of dialogue execution modules include a situation verbalization & resource description framework (RDF) knowledge-based dialogue execution module that executes verbalization processing of situation information and retrieves an RDF knowledge database to generate a system utterance based on situation verbalization data generated through the verbalization processing, the RDF knowledge database being a database in which elements included in various information and relationships between the elements are recorded.

(12) The information processing device according to any one of (1) to (11), wherein the plurality of dialogue execution modules include a machine learning model-based dialogue execution module that generates a system utterance using a machine learning model generated through machine learning processing of set data including input sentences and response sentences.

(13) The information processing device according to any one of (1) to (12), wherein the data processing unit includes

a state analysis unit that inputs external information including speech information from an input unit and generates state information in units of times which is external state analysis information in units of times,
a situation analysis unit that continuously inputs the state information and generates external situation information based on a plurality of pieces of input state information, and
a processing determination unit that inputs the situation information generated by the situation analysis unit and determines processing to be executed by the information processing device, and
the processing determination unit inputs the situation information to the plurality of dialogue execution modules, acquires a plurality of system utterances individually generated based on the situation information by the plurality of dialogue execution modules, and selects one system utterance to be output from the plurality of acquired system utterances.

(14) An information processing system including:

a robot control device that controls a dialogue robot; and
a server that is able to communicate with the robot control device, wherein
the robot control device outputs situation information input through an input unit to the server,
the server includes a plurality of dialogue execution modules that generate system utterances in accordance with different system utterance generation algorithms,
each of the plurality of dialogue execution modules generates an individual system utterance based on the situation information and transmits the generated system utterance to the robot control device, and
the robot control device selects one system utterance from among the plurality of system utterances received from the server and outputs the selected system utterance.

(15) The information processing system according to (14), wherein the robot control device selects a system utterance having a high value of the degree of confidence as a system utterance to be output, with reference to a system utterance-compatible degree of confidence which is set to correspond to the system utterance generated by each of the plurality of dialogue execution modules.

(16) The information processing system according to (15), wherein in a case where there are a plurality of system utterances having a maximum value of the degree of confidence, the robot control device selects a system utterance generated by a dialogue execution module having a high priority as an output system utterance in accordance with a predefined dialogue execution module-compatible priority.

(17) An information processing method executed in an information processing device, wherein

the information processing device includes a data processing unit that generates and outputs a system utterance, and
the data processing unit selects one system utterance from among a plurality of system utterances individually generated by a plurality of dialogue execution modules and outputs the selected system utterance.

(18) An information processing method executed in an information processing system including a robot control device that controls a dialogue robot, and a server that is able to communicate with the robot control device, wherein

the robot control device outputs situation information input through an input unit to the server,
the server includes a plurality of dialogue execution modules that generate system utterances in accordance with different system utterance generation algorithms,
each of the plurality of dialogue execution modules generates an individual system utterance based on the situation information and transmits the generated system utterance to the robot control device, and
the robot control device selects one system utterance from among the plurality of system utterances received from the server and outputs the selected system utterance.

(19) A program for executing information processing in an information processing device, wherein

the information processing device includes a data processing unit that generates and outputs a system utterance, and
the program causes the data processing unit to select one system utterance from among a plurality of system utterances individually generated by a plurality of dialogue execution modules and output the selected system utterance.

The series of processing described in the specification can be executed by hardware, software, or a composite configuration of both. When the processes are performed by software, a program including the process sequence can be installed in and executed by a memory of a computer assembled into exclusive hardware. Alternatively, the program can be installed in and executed by a general-purpose computer performing various processes. For example, the program can be recorded in advance on a recording medium. The program cannot only be installed in a computer from a recording medium but may be also received through a network such as a LAN (Local Area Network) and the Internet and installed in a recording medium such as a built-in hard disk.

The various processes described in this specification can be performed consecutively in the described order or may be performed in parallel or individually depending on the processing capability of the device performing the processes or as needed. In the present specification, the system is a logical set of configurations of a plurality of devices, and the devices having each configuration are not limited to those in the same housing.

### INDUSTRIAL APPLICABILITY

As described above, according to a configuration of an example of the present disclosure, it is possible to realize a configuration in which an optimum system utterance is selected and output from a plurality of system utterances generated by a plurality of dialogue execution modules that generate system utterances in accordance with different algorithms.

Specifically, for example, a data processing unit generating and outputting system utterances selects one system utterance from among a plurality of system utterances individually generated by the plurality of dialogue execution modules and outputs the selected system utterance. Each of the plurality of dialogue execution modules generates algorithm-specific system utterances in accordance with different algorithms. The data processing unit selects one system utterance to be output in accordance with the degree of confidence which is set to correspond to a system utterance generated by each of the plurality of dialogue execution modules and a predefined dialogue execution module-compatible priority. According to the present configuration, it is possible to realize a configuration in which an optimum system utterance is selected and output from a plurality of system utterances generated by a plurality of dialogue execution modules generating system utterances in accordance with different algorithms.

### REFERENCE SIGNS LIST

10 Dialogue robot
21 Server
22 Smartphone
23 PC
100 Information processing device
110 Data input and output unit
120 Input unit
121 Speech input unit
122 Image input unit
123 Sensor
130 Output unit
131 Speech output unit
132 Driving control unit
150 Robot control unit
160 Data processing unit
161 State analysis unit
162 Situation analysis unit
163 Processing determination unit (decision making unit)
164 Dialogue processing unit
165 Action processing unit
170 Communication unit
201 Scenario-based dialogue execution module
202 Episode knowledge-based dialogue execution module
203 RDF knowledge-based dialogue execution module
204 Situation verbalization & RDF knowledge-based dialogue execution module
205 Machine learning model-based dialogue execution module
210 Execution processing determination unit
211 Scenario database
212 Episode knowledge database
213 RDF knowledge database
215 Machine learning model
501 CPU
502 ROM
503 RAM
504 Bus
505 Input/output interface
506 Input unit
507 Output unit
508 Storage unit
509 Communication unit
510 Drive
511 Removable medium

1. An information processing device comprising:
a data processing unit configured to generate and output a system utterance, wherein
the data processing unit selects one system utterance from among a plurality of system utterances individually generated by a plurality of dialogue execution modules and outputs the selected system utterance.

2. The information processing device according to claim 1, wherein
each of the plurality of dialogue execution modules generates a system utterance specific to an algorithm in accordance with different system utterance generation algorithms.

3. The information processing device according to claim 1, wherein
the data processing unit
inputs a user utterance, inputs a speech recognition result of the input user utterance to the plurality of dialogue execution modules, and
selects one system utterance from among system utterances generated based on the user utterance by the plurality of dialogue execution modules.

4. The information processing device according to claim 1, wherein
the data processing unit
inputs situation information which is observation information, inputs the input situation information to the plurality of dialogue execution modules, and
selects one system utterance from among system utterances generated based on the situation information by the plurality of dialogue execution modules.

5. The information processing device according to claim 1, wherein
the data processing unit selects a system utterance having a high value of the degree of confidence as an output system utterance, with reference to a system utterance-compatible degree of confidence which is set to correspond to the system utterance generated by each of the plurality of dialogue execution modules.

6. The information processing device according to claim 5, wherein
in a case where there are a plurality of system utterances having a maximum value of the degree of confidence, the data processing unit selects a system utterance generated by a dialogue execution module having a high priority as an output system utterance in accordance with a predefined dialogue execution module-compatible priority.

7. The information processing device according to claim 1, wherein
each of the plurality of dialogue execution modules generates a generated system utterance and the degree of confidence corresponding to the generated system utterance, and
the data processing unit selects a system utterance having a high value of the degree of confidence as an output system utterance.

8. The information processing device according to claim 1, wherein the plurality of dialogue execution modules include a scenario-based dialogue execution module that generates a system utterance with reference to a scenario database in which utterance set data including user utterances corresponding to various dialogue scenarios and system utterances is registered.

9. The information processing device according to claim 1, wherein the plurality of dialogue execution modules include an episode knowledge-based dialogue execution module that generates a system utterance with reference to an episode knowledge database in which various episode information is recorded.

10. The information processing device according to claim 1, wherein the plurality of dialogue execution modules include a resource description framework (RDF) knowledge-based dialogue execution module that generates a system utterance with reference to an RDF knowledge database in which elements included in various information and relationships between the elements are recorded.

11. The information processing device according to claim 1, wherein the plurality of dialogue execution modules include a situation verbalization & resource description framework (RDF) knowledge-based dialogue execution module that executes verbalization processing of situation information and retrieves an RDF knowledge database to generate a system utterance based on situation verbalization data generated through the verbalization processing, the RDF knowledge database being a database in which elements included in various information and relationships between the elements are recorded.

12. The information processing device according to claim 1, wherein the plurality of dialogue execution modules include a machine learning model-based dialogue execution module that generates a system utterance using a machine learning model generated through machine learning processing of set data including input sentences and response sentences.

13. The information processing device according to claim 1, wherein
the data processing unit includes
a state analysis unit that inputs external information including speech information from an input unit and generates state information in units of times which is external state analysis information in units of times,
a situation analysis unit that continuously inputs the state information and generates external situation information based on a plurality of pieces of input state information, and
a processing determination unit that inputs the situation information generated by the situation analysis unit and determines processing to be executed by the information processing device, and
the processing determination unit inputs the situation information to the plurality of dialogue execution modules, acquires a plurality of system utterances individually generated based on the situation information by the plurality of dialogue execution modules, and selects one system utterance to be output from the plurality of acquired system utterances.

14. An information processing system comprising:
a robot control device that controls a dialogue robot; and
a server that is able to communicate with the robot control device, wherein
the robot control device outputs situation information input through an input unit to the server,
the server includes a plurality of dialogue execution modules that generate system utterances in accordance with different system utterance generation algorithms,
each of the plurality of dialogue execution modules generates an individual system utterance based on the situation information and transmits the generated system utterance to the robot control device, and
the robot control device selects one system utterance from among the plurality of system utterances received from the server and outputs the selected system utterance.

15. The information processing system according to claim 14, wherein the robot control device selects a system utterance having a high value of the degree of confidence as a system utterance to be output, with reference to a system utterance-compatible degree of confidence which is set to correspond to the system utterance generated by each of the plurality of dialogue execution modules.

16. The information processing system according to claim 15, wherein in a case where there are a plurality of system utterances having a maximum value of the degree of confidence, the robot control device selects a system utterance generated by a dialogue execution module having a high priority as an output system utterance in accordance with a predefined dialogue execution module-compatible priority.

17. An information processing method executed in an information processing device, wherein
the information processing device includes a data processing unit that generates and outputs a system utterance, and
the data processing unit selects one system utterance from among a plurality of system utterances individually generated by a plurality of dialogue execution modules and outputs the selected system utterance.

18. An information processing method executed in an information processing system including a robot control device that controls a dialogue robot, and a server that is able to communicate with the robot control device, wherein
the robot control device outputs situation information input through an input unit to the server,
the server includes a plurality of dialogue execution modules that generate system utterances in accordance with different system utterance generation algorithms,
each of the plurality of dialogue execution modules generates an individual system utterance based on the situation information and transmits the generated system utterance to the robot control device, and
the robot control device selects one system utterance from among the plurality of system utterances received from the server and outputs the selected system utterance.

19. A program for executing information processing in an information processing device, wherein
the information processing device includes a data processing unit that generates and outputs a system utterance, and
the program causes the data processing unit to select one system utterance from among a plurality of system utterances individually generated by a plurality of dialogue execution modules and output the selected system utterance.
